(19) United States
(12) Patent Application Publication
(10) Pub. No.: US 2010/0085114 A1
(43) Pub. Date: Apr. 8, 2010

(54) HIGH-VOLTAGE GENERATION CIRCUIT AND SEMICONDUCTOR STORAGE DEVICE PROVIDED THEREWITH AND SEMICONDUCTOR INTEGRATED DEVICE

(76) Inventors: Mario SAKO, Yokohama-shi (JP); Masaaki Kuwagata, Yokohama-shi (JP); Gyosho Chin, Kyoto-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/564,359

(22) Filed: Sep. 22, 2009

(30) Foreign Application Priority Data
Oct. 3, 2008 (JP) 2008-258736

(51) Int. Cl. G05F 1/10

(52) U.S. Cl. 327/538

(57) ABSTRACT

A voltage generation circuit includes a pump circuit, a first unit, a first switch, and a first capacitor. The pump circuit generates a first voltage and outputs the first voltage to a first node. The first unit includes a first resistance unit to output a second voltage at a second node. The first switch connects the second node and an output terminal. A resistance value of a parasitic resistance formed in an interconnection from the second node to the output terminal is smaller than a resistance value of the first resistance unit. The first capacitor includes one of electrodes and the other electrodes. The one of electrodes is connected to an interconnection connecting the second node and the first switch element. The other of the electrodes is grounded. A capacitance of the first capacitor element is larger than a capacitance connected to the output terminal.

### CROSS-REFERENCE TO RELATED APPLICATIONS

This application is based upon and claims the benefit of priority from prior Japanese Patent Application No. 2008-258736, filed Oct. 3, 2008, the entire contents of which are incorporated herein by reference.

### BACKGROUND OF THE INVENTION

1. Field of the Invention

The present invention relates to a voltage generation circuit and a semiconductor storage device provided therewith.

2. Description of the Related Art

In a semiconductor storage device including an EEPROM, a voltage larger than an internal voltage of the semiconductor storage device is required in a data write operation and a data erase operation.

The semiconductor storage device in which the high voltage is required incorporates a boosting circuit (pump circuit) therein, and the boosting circuit boosts a power supply voltage to generate the required high voltage.

For example, Jpn. Pat. Appln. KOKAI Publication Nos. 2000-105998 and 2000-268575 disclose a conventional voltage generation circuit including a standby boosting circuit that is operated according to an output voltage in a standby state and an active boosting circuit that is operated according to the output voltage in an active state.

### BRIEF SUMMARY OF THE INVENTION

A voltage generation circuit according to aspect of the present invention includes,

a pump circuit which generates a first voltage and outputs the first voltage to a first node;

a first voltage generation unit which includes a first resistance unit to output a second voltage at a second node, one end of the first resistance unit being connected to the first node, the first resistance unit dividing the first voltage to generate the second voltage;

a first switch element which connects the second node and an output terminal, a resistance value of a parasitic resistance formed in an interconnection from the second node to the output terminal being smaller than a resistance value of the first resistance unit; and

a first capacitor element in which one of electrodes is connected to an interconnection connecting the second node and the first switch element while the other of the electrodes is grounded, a capacitance of the first capacitor element being larger than a capacitance connected to the output terminal.

### BRIEF DESCRIPTION OF THE SEVERAL VIEWS OF THE DRAWING

FIG. 1 is a block diagram illustrating a configuration example of a semiconductor storage device provided with a voltage generation circuit according to a first embodiment of the invention;

FIG. 2 is a circuit diagram illustrating a memory cell array of the first embodiment;

FIG. 3 illustrates a threshold distribution of a memory cell transistor of the first embodiment;

FIG. 4 is a block diagram illustrating a high-voltage generation circuit of the first embodiment;

FIG. 5 illustrates a delay circuit that outputs a control signal SW11 in the high-voltage generation circuit of the first embodiment;

FIG. 6 illustrates a voltage switching operation performed by a generation unit in the high-voltage generation circuit of the first embodiment;

FIG. 7 illustrates a read voltage switching operation performed by the high-voltage generation circuit of the first embodiment;

FIG. 8 is a block diagram illustrating a high-voltage generation circuit according to a second embodiment of the invention;

FIG. 9 is a block diagram illustrating a first voltage generation unit of the high-voltage generation circuit of the second embodiment;

FIGS. 10 and 11 are circuit diagrams illustrating the first voltage generation unit of the second embodiment;

FIG. 12 is a graph illustrating an I-V characteristic of the first voltage generation unit of FIG. 10;

FIG. 13 is a graph illustrating an I-V characteristic of a second voltage generation unit of FIG. 10;

FIG. 14 is a circuit diagram illustrating a configuration example of a comparator in the first voltage generation unit of FIG. 10;

FIG. 15 is a circuit diagram illustrating a configuration example of a limiting circuit of FIG. 14;

FIG. 16 is a block diagram illustrating a first voltage generation unit according to a third embodiment of the invention;

FIG. 17 illustrates a read voltage output operation performed by the first voltage generation unit of the third embodiment;

FIG. 18 illustrates a read voltage stop operation performed by the first voltage generation unit of the third embodiment;

FIG. 19 is a block diagram illustrating a first voltage generation unit according to a modification of the third embodiment;

FIG. 20 is a block diagram illustrating a configuration example of a semiconductor storage device provided with a voltage generation circuit according to a fourth embodiment of the invention;

FIG. 21 illustrates a threshold distribution of a memory cell transistor of the fourth embodiment;

FIG. 22 is a block diagram illustrating a charge unit included in a generation unit of the fourth embodiment;

FIG. 23 illustrates a voltage switching operation performed by the generation unit in the high-voltage generation circuit of the fourth embodiment;

FIGS. 24A and 24B are graphs illustrating a data write method of the fourth embodiment; and

FIG. 25 illustrates a voltage switching operation performed by the generation unit in the high-voltage generation circuit of the fourth embodiment.

### DETAILED DESCRIPTION OF THE INVENTION

Embodiments of the invention will be described below with reference to the drawings. In the following drawings, a common component is designated by the same numeral. In the following embodiments, a NOR-type flash memory is described by way of example.

### First Embodiment

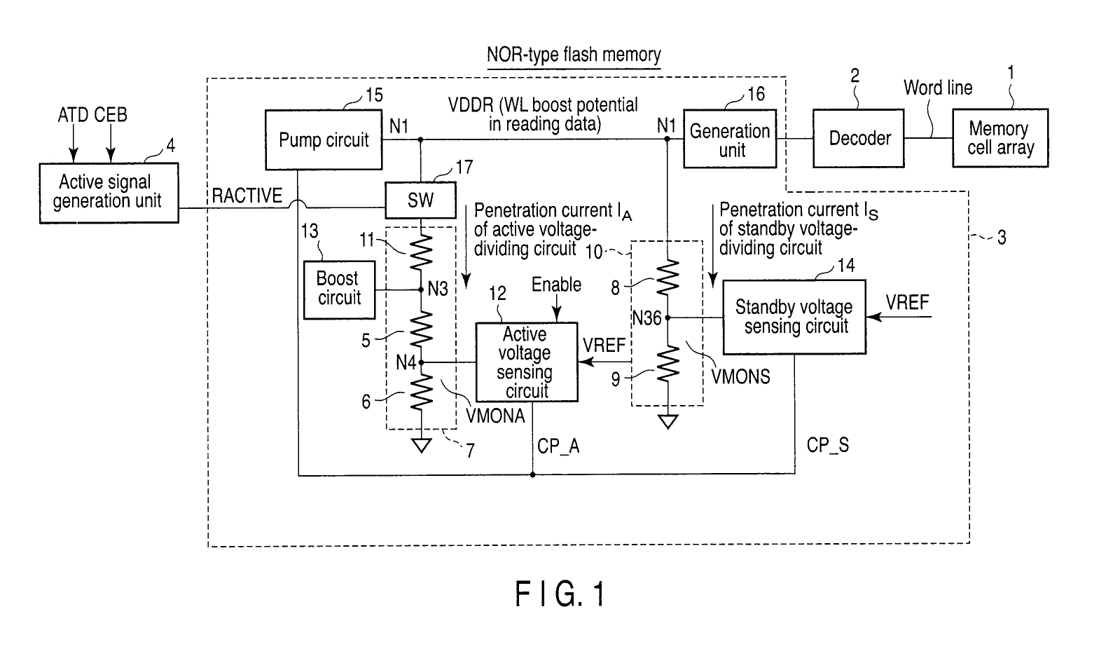

FIG. 1 illustrates a configuration example of a voltage generation circuit and a semiconductor storage device provided with the voltage generation circuit according to a first embodiment of the invention. Referring to FIG. 1, a NOR-type flash memory includes a memory cell array 1, a decoder 2, a high-voltage generation circuit 3, and an active signal generation circuit 4.

(Configuration Example of Memory Cell Array 1)

The memory cell array 1 includes a plurality of nonvolatile memory cells each of which can hold data. The memory cell is an n-channel type MOS transistor provided with a stacked gate including a charge accumulation layer and a control gate. The control gate of the memory cell acts as a word line, a drain is electrically connected to a bit line, and a source is electrically connected to a source line.

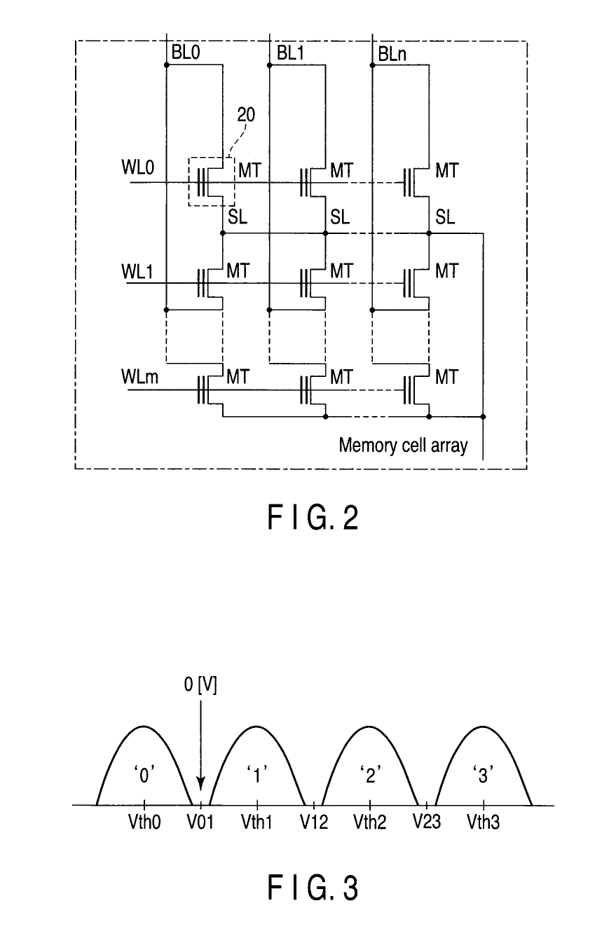

The memory cell array 1 will be described with reference to FIG. 2. As illustrated in FIG. 2, the memory cell array 1 includes (m+1)×(n+1) memory cell transistors MT (m and n are natural numbers) arranged in a matrix pattern. For example, the memory cell transistor MT is an n-channel type MOS transistor including a MONOS-type stacked gate. The MONOS-type stacked gate has the following configuration. That is, the stacked gate includes the charge accumulation layer (insulating film), an insulating film (hereinafter referred to as block layer), an insulating film, and the control gate. The charge accumulation layer is formed on a p-type semiconductor substrate with a gate insulating film interposed therebetween. The block layer is formed on the charge accumulation layer and has a permittivity higher than that of the charge accumulation layer. The insulating film is formed on the block layer. The control gate is formed on the insulating film. The sources of the memory cell transistors MT are commonly connected to a source line SL. That is, in the configuration of the memory cell array 1, the memory cell transistors MT are arranged in a matrix pattern, and a bit line BL and a word line WL are connected in each memory cell transistor MT.

The control gates of the memory cell transistors MT located in the same row are commonly connected to one of word lines WL0 to WLm. For the sake of convenience, hereinafter sometimes the word lines WL0 to WLm are simply referred to as word line WL unless distinguished from one another. In the memory cell array 1, the drains of the memory cell transistors MT located in the same column are commonly connected to one of bit lines BL0 to BLn (n is a natural number). Hereinafter, sometimes the bit lines BL0 to BLn are collectively referred to as bit line BL unless distinguished from one another.

(Threshold Distribution of Memory Cell Transistor MT)

A threshold distribution of the memory cell transistor MT will be described below with reference to FIG. 3. FIG. 3 is a graph in which an abscissa represents a threshold distribution and an ordinate represents a probability of existence of a memory cell transistor MT.

As illustrated in FIG. 3, each memory cell transistor MT holds one of pieces of four-level data (two-bit data). That is, the memory cell transistor MT has four thresholds ‘0’, ‘1’, ‘2’, and ‘3’ in ascending order of threshold voltage Vth. A voltage Vth0 of the ‘0’ data is in a range of Vth0<V01. A threshold voltage Vth1 of the ‘1’ data is in a range of V01<Vth1<V12. A threshold voltage Vth2 of the ‘2’ data is in a range of V12<Vth2<V23. A threshold voltage Vth3 of the ‘3’ data is in a range of V23<Vth3.

For example, in the first embodiment, when the voltage V01 is set to 0 V, the threshold voltage Vth0 of the ‘0’ data has a negative value, and the threshold voltages Vth1 to Vth3 of the ‘1’ data to the ‘3’ data have positive values. In the ‘0’ data to ‘3’ data, a read level of the ‘0’ data is a negative value, and read levels of the ‘1’ data to ‘3’ data are positive values. In reading the data, a voltage corresponding to the read level is applied between the gate and source of the memory cell transistor MT.

Thus, the memory cell transistor MT can hold the two-bit data of the ‘0’ data to ‘3’ data according to the threshold. The threshold voltage is fluctuated by injecting a charge into the charge accumulation layer. The positive read voltage is not limited to the voltage V01.

The data that can be held by the memory cell transistor MT is not limited to the four values. For example, the data held by the memory cell transistor MT may be 8 values (three-bit data) or 16 values (four-bit data). The memory cell transistor MT may hold data having 16 values or more.

(Decoder 2)

The decoder 2 will be described with reference to FIG. 1. The decoder 2 selects a row direction of the memory cell array 1 based on a row address supplied from a control unit (not illustrated). That is, the decoder selects a word line WL. The decoder 2 applies a predetermined voltage, generated by the high-voltage generation circuit 3, to the selected word line WL.

(Detailed High-Voltage Generating Circuit 3)

The high-voltage generation circuit 3 of the first embodiment, particularly a configuration for generation a read voltage VDDR will be described in detail.

The high-voltage generation circuit 3 includes an active voltage-dividing circuit 7, a switch circuit SW17, an active voltage sensing circuit 12, a standby voltage-dividing circuit 10, a boost circuit 13, a standby voltage sensing circuit 14, a pump circuit 15, and a generation unit 16. When the high-voltage generation circuit 3 is in a standby state, the active signal generation circuit 4 puts the switch circuit SW17 in an off state.

(Active Signal Generation Circuit 4)

First the active signal generation circuit 4 will be described. The active signal generation circuit 4 outputs a signal RACTIVE to the switch circuit SW17. That is, the active signal generation circuit 4 sets the signal RACTIVE to an ‘L’ level when the high-voltage generation circuit 3 is in the standby state, and the active signal generation circuit 4 sets the signal RACTIVE to an ‘H’ level when the high-voltage generation circuit 3 is in the active state. The active signal generation circuit 4 produces the signal RACTIVE based on an input of a chip enable signal CEB indicating that a chip is selected, or a signal ATD for defining a read operation.

(Switch Element 17)

A node N1 is connected to one end of the switch element 17, and the other end of the switch element 17 is connected to one end of a current pathway of the active voltage-dividing circuit 7. The switch element 17 sets a switch in the off state when receiving the ‘L’ level as the signal RACTIVE from the active signal generation circuit 4, and the switch element 17 sets the switch in the on state when receiving the ‘H’ level as the signal RACTIVE from the active signal generation circuit 4. That is, the node N1 and the active voltage-dividing circuit 7 are electrically connected when the switch element 17 is in the on state, and the node N1 and the active voltage-dividing circuit 7 are put in a non-conduction state when the switch element 17 is in the off state.

(Pump Circuit 15)

For example, the pump circuit 15 includes a charge pump. The pump circuit 15 generates the voltage VDDR based on a signal CP_S when the high-voltage generation circuit 3 is in the standby state, and the pump circuit 15 generates the voltage VDDR based on a signal CP_A when the high-voltage generation circuit 3 is in the active state. Then, the pump circuit 15 outputs the voltage VDDR to the node N1. That is, the pump circuit 15 outputs the voltage VDDR even in the standby state such that a transition can rapidly be made from the standby state to the active state. In the pump circuit 15, the pump circuits may separately be provided for the active voltage sensing circuit 12 and the standby voltage sensing circuit 14.

(Generation Unit 16)

Using the voltage VDDR supplied from the pump circuit 15 through the node N1, the generation unit 16 produces a voltage that should be transferred to the memory cell array 1. The voltage produced by the generation unit 16 is described later.

(Active Voltage-Dividing Circuit 7)

The active voltage-dividing circuit 7 includes resistor elements 5, 6, and 11. One end of the resistor element 11 is connected to the node N1 through the switch circuit SW17, the other end of the resistor element 11 is connected to one end of the resistor element 5 through a node N3, and the other end of the resistor element 5 is connected to one end of the resistor element 6 through a node N4. The other end of the resistor element 6 is grounded.

A penetration current I_{A} is not passed through the active voltage-dividing circuit 7 when switch circuit SW17 is in the off state by the signal RACTIVE supplied from the active signal generation circuit 4. On the other hand, when the switch circuit SW17 is in the on state, the penetration current I_{A} is passed through the active voltage-dividing circuit 7, and the voltage at the node N1 is divided by the resistor elements 5, 6, and 11. The voltage at the node N4 is set to the voltage VMONA.

(Boost Circuit 13)

The boost circuit 13 is connected to a node 3 at which the other end of the resistor element 11 and one end of the resistor element 5 are connected. The boost circuit 13 boosts the voltage at the node N3 at the same time as the switch element 17 is switched from the off state (standby state) to the on state (active state).

(Active Voltage Sensing Circuit 12)

When receiving an enable signal, the active voltage sensing circuit 12 compares the voltage VMONA at the node N4 and a reference voltage VREF that is fed into the active voltage sensing circuit 12 and produced by a BGR circuit. That is, the active voltage sensing circuit 12 controls the voltage VDDR output from the pump circuit 15 such that the reference voltage VREF fed into the active voltage sensing circuit 12 and the voltage VMONA at the node N4 are matched with each other. The active voltage sensing circuit 12 compares the reference voltage VREF and the voltage VMONA. When the reference voltage VREF is the voltage VMONA or less, the active voltage sensing circuit 12 outputs the ‘L’-level signal as the signal CP_A to the pump circuit 15, whereby the pump circuit 15 stops the pumping. When the reference voltage VREF is more than the voltage VMONA, the active voltage sensing circuit 12 outputs the signal CP_A at the ‘H’ level as to the pump circuit 15, whereby the pump circuit 15 performs the pumping to boost the output voltage. The enable signal means a signal that is supplied when the voltage VMONA settles into a constant value after the penetration current I_{A} is passed through the active voltage-dividing circuit.

(Standby Voltage-Dividing Circuit 10)

The standby voltage-dividing circuit 10 includes resistor elements 8 and 9. One end of the resistor element 8 is connected to the node N1, the other end of the resistor element 8 is connected to one end of the resistor element 9, and the other end of the resistor element 9 is grounded. In a node N36, the other end of the resistor element 8 and one end of the resistor element 9 are connected to each other.

A penetration current I_{S} is passed through the standby voltage-dividing circuit 10 when the switch circuit SW17 is in the off state by the signal RACTIVE supplied from the active signal generation circuit 4, that is, when the high-voltage generation circuit 3 is in the standby state. Therefore, the voltage at the node N1 is divided by the resistor element 8 and the resistor element 9. That is, the voltage at the node N1 is divided by the resistor element 8 and resistor element 9, which are included in the standby voltage-dividing circuit 10. The voltage at the node N36 is set to a voltage VMONS. A combined resistance value of the resistor elements 8 and 9 is set larger than a combined resistance value of the resistor element 5, 6, and 11 included in the active voltage-dividing circuit 7. Accordingly, the penetration current I_{S} is smaller than the penetration current I_{A}.

(Standby Voltage Sensing Circuit 14)

The standby voltage sensing circuit 14 compares the voltage VMONS at the node N36 and the reference voltage VREF that is fed into the standby voltage sensing circuit 14 and produced by the BGR circuit. That is, the standby voltage sensing circuit 14 controls the voltage VDDR supplied from the pump circuit 15 such that the reference voltage VREF fed into the standby voltage sensing circuit 14 and the voltage VMONS at the node N36 match each other. Specifically, the standby voltage sensing circuit 14 compares the reference voltage VREF and the voltage VMONS. When the reference voltage VREF is the voltage VMONS or less, the standby voltage sensing circuit 14 outputs the signal CP_S at an ‘L’ level to the pump circuit 15, whereby the pump circuit 15 stops the pumping. When the reference voltage VREF is more than the voltage VMONS, the standby voltage sensing circuit 14 outputs the signal CP_S at an ‘H’ level to the pump circuit 15, whereby the pump circuit 15 performs the pumping to boost the output voltage.

(Configuration Example of Generation Unit 16)

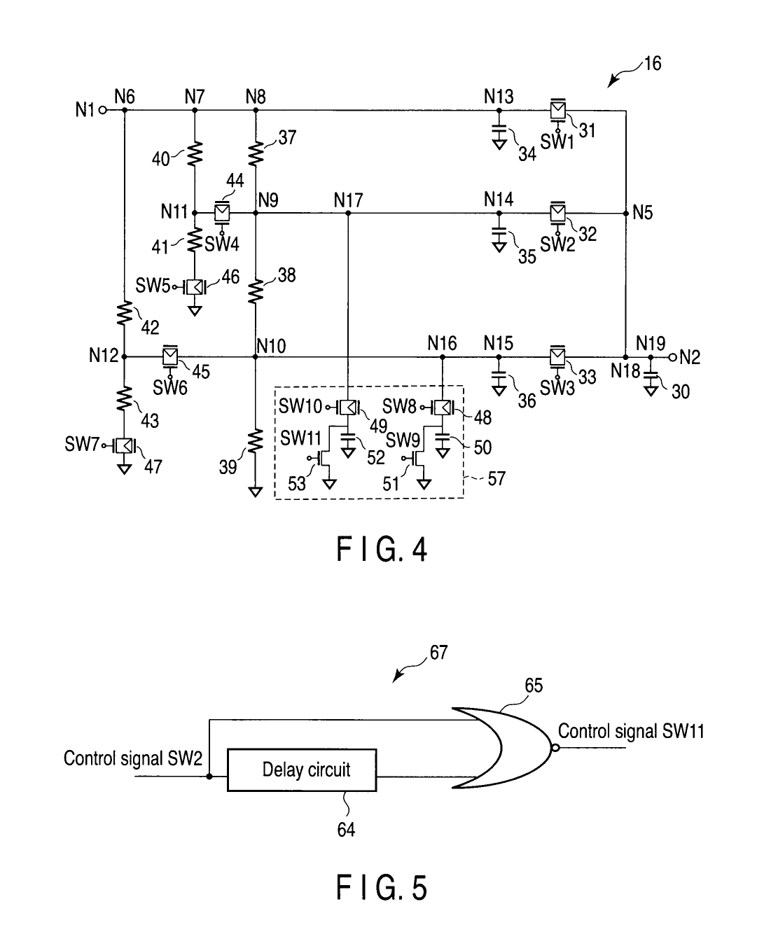

A detailed configuration of an example of the generation unit 16 in the NOR-type flash memory will be described with reference to FIG. 4. FIG. 4 is a circuit diagram illustrating the generation unit 16 in detail. As illustrated in FIG. 4, the generation unit 16 includes a parasitic capacitor element 30, switch elements 31 to 33 and 44 to 47, capacitor elements 34 to 36, resistor elements 37 to 43, and a discharge unit 57.

The voltage VDDR generated by the pump circuit 15 is fed into the node N1. The voltage VDDR is supplied from the node N1 to nodes N6, N7, N8 and N13 commonly connected to the node N1.

The voltage VDDR at the node N8 is divided by the resistor elements 37 to 39. That is, one end of the resistor element 37 is connected to the node N8. At the node N9, the other end of the resistor element 37 is connected to the one end of the resistor element 38. At the node N10, the other end of the resistor element 38 and one end of the resistor element 39 are connected to each other. The other end of the resistor element 39 is grounded. The voltage at the node N9 is set to a voltage VDDR1 and the voltage at the node N10 is set to a voltage VDDR2. That is, the resistor elements 37 to 39 act as a voltage generation unit that generates the voltages VDDR to VDDR2. The voltage VDDR1 is a value in which a voltage corresponding to a voltage drop in the resistor element 37 is subtracted from the voltage VDDR, and the voltage VDDR2 is a value in which a voltage corresponding to a voltage drop in the resistor element 38 is further subtracted from the voltage VDDR1. That is, a relationship of VDDR>VRRD1>VDDR2 holds. The voltage VDDR1 is supplied from the node N9 to nodes N17, N14, and N18 commonly connected to the node N9. The voltage VDDR2 is supplied from the node N10 to nodes N16, N15, and N18 commonly connected to the node N10.

The voltage VDDR at the node N7 is divided by the resistor element 40 and 41. That is, one end of the resistor element 40 is connected to the node N7. At the node N11, the other end of the resistor element 40 and one end of the resistor element 41 are connected to each other. The other end of the resistor element 41 is grounded through the switch element 46. A control signal SW5 is supplied to the switch element 46. The nodes N11 and N9 are connected to each other through the switch element 44. A control signal SW4 is supplied to the switch element 44. When the switch element 44 enters the on state by the control signal SW4, the resistor elements 37 and 40 are connected in parallel. When the switch element 46 enters the on state by the control signal SW5, the resistor elements 37 and 40 are connected in parallel, and the resistor elements 38 and 39 and the resistor element 41 are connected in parallel.

The voltage VDDR at the node N6 is divided by the resistor elements 42 and 43. That is, one end of the resistor element 42 is connected to the node N6. At the node N12, the other end of the resistor element 42 and one end of the resistor element 43 are connected to each other. The other end of the resistor element 43 is grounded through the switch element 47. A control signal SW7 is supplied to the switch element 47. The nodes N12 and N10 are connected to each other through the switch element 45. A control signal SW6 is supplied to the switch element 45. That is, when the switch element 45 enters the on state by the control signal SW6, the resistor elements 37 and 38 and the resistor element 42 are connected in parallel. In addition to the parallel connection, when the switch element 47 enters the on state by the control signal SW7, the resistor element 39 and the resistor element 43 are connected in parallel. The switch element 44 enters the on state after a potential at the node N11 is equalized to a potential at the node N9, that is, the node N11 attains the voltage VDDR1 since the switch element 46 is set to the on state. Similarly, the switch element 45 enters the on state after a potential at the node N12 is equalized to a potential at the node N10, that is, the node N12 attains the voltage VDDR2 since the switch element 47 is set to the on state.

The capacitor element 34 is charged by the voltage VDDR at the node N13. That is, the node N13 is connected to one of the electrodes of the capacitor element 34, and the other electrode is grounded. The node N18 is connected to the node N13 through the switch element 31. A control signal SW1 is supplied to the switch element 31. The switch element 31 takes one of the on state and the off state in response to the control signal SW1.

The capacitor element 35 is charged by the voltage VDDR1 at the node N9. That is, the node N14 is connected to one of the electrodes of the capacitor element 35, and the other electrode is grounded. The node N18 is connected to the node N14 through the switch element 32 and the node N5. That is, the switch element 31 and the switch element 32 are commonly connected. A control signal SW2 is supplied to the switch element 32. The switch element 32 takes one of the on state and the off state in response to the control signal SW2.

The capacitor element 36 is charged by the voltage VDDR2 at the node N15. That is, the node N15 is connected to one of electrodes of the capacitor element 36, and the other electrode is grounded. The node N18 is connected to the node N15 through the switch element 33. That is, the switch elements 31 to 33 are commonly connected at the node N18. A control signal SW3 is supplied to the switch element 33. The switch element 33 takes one of the on state and the off state in response to the control signal SW3.

The node N18 is connected to the output node N2 through the node N19. That is, one of the potentials of the voltages VDDR to VDDR2 at the node N18 is output from the output node N2. The parasitic capacitor element 30 is charged by one of the voltages VDDR to VDDR2 at the node N19. That is, the node N19 is connected to one of the electrodes of the parasitic capacitor element 30, and the other electrode is grounded. Relationships of C1>>Cout, C2>>Cout, and C3>>Cout are obtained. Where Cout is a capacitance of the parasitic capacitor element 30, C1 is a capacitance of the capacitor element 34, C2 is a capacitance of the capacitor element 35, and C3 is a capacitance of the capacitor element 36. At this point, each of the capacitances C1 to C3 is larger than at least the capacitance Cout, and preferably the capacitances C1 to C3 of the capacitor elements 34 to 36 are 100 or more times the capacitance Cout of the parasitic capacitor element 30. Examples of parasitic capacitor elements include a resistor element, a capacitor element, and a MOS transistor, which are provided in the decoder 2 or memory cell array 1.

Furthermore, the discharge unit 57 discharges a charge corresponding to a potential difference between the nodes N19 and N17 and a charge corresponding to a potential difference between the nodes N19 and N16. That is, the discharge unit 57 discharges the charge corresponding to the voltage (VDDR−VDDR1) and the charge corresponding to the voltage (VDDR1−VDDR2).

The discharge unit 57 will be described below in detail. Referring to FIG. 4, the discharge unit 57 includes switch elements 48 and 49, capacitor elements 50 and 52, and MOS transistors 51 and 53.

The node N16 is connected to one of the electrodes of the capacitor element 50 through the switch element 48. The other electrode of the capacitor element 50 is grounded. One end of a current pathway of the MOS transistor 51 is connected to one of the electrodes of the capacitor element 50, the other end of the current pathway is grounded, and a signal is fed into a gate of the MOS transistor 51 from the control unit (not illustrated). That is, the node N16, one of the electrodes of the capacitor element 50, and one end of the current pathway of the MOS transistor 51 are commonly connected through the switch element 48. It is assumed that C_{cs1} is a capacitance of the capacitor element 50. A control signal SW8 is supplied to the switch element 48. The switch element 48 is set to the on state or the off state by the control signal SW8. A control signal SW9 is supplied to the gate of the MOS transistor 51.

Similarly, the node N17 is connected to one of the electrodes of the capacitor element 52 through the switch element 49. The other electrode of the capacitor element 52 is grounded. One end of a current pathway of the MOS transistor 53 is connected to one of the electrodes of the capacitor element 52, the other end of the current pathway is grounded, and the signal is fed into the gate of the MOS transistor 53 from the control unit (not illustrated). That is, the node N17, one of the electrodes of the capacitor element 52, and one end of the current pathway of the MOS transistor 53 are commonly connected through the switch element 49. It is assumed that C_{cs2} is a capacitance of the capacitor element 52. A control signal SW10 is supplied to the switch element 49. The switch element 49 is set to the on state or the off state by the control signal SW10. A control signal SW11 is supplied to the gate of the MOS transistor 53.

The control unit (not illustrated) supplies the control signals SW9 and SW11 at ‘H’-level to the gates of the MOS transistors 51 and 53, whereby the MOS transistors 51 and 53 enter the on state. Therefore, because the capacitor elements 50 and 52 are grounded through the MOS transistors 51 and 53, the charges in the capacitor elements 50 and 52 are discharged. FIG. 5 illustrates an example of a circuit that outputs the control signal SW11 to the gate of the MOS transistor 53. The circuit of FIG. 5 is a delay circuit that delays a time the MOS transistor 53 takes the on state with respect to the control signal SW2 supplied to the switch element 32. As illustrated in FIG. 5, a control signal generation unit 67 includes a delay circuit 64 and a NOR circuit 65. The delayed control signal SW2 is fed into the NOR circuit 65. That is, the control signal SW2 is directly fed into one input end of the NOR circuit 65, and the control signal SW2 is fed into the other input end of the NOR circuit 65 through the delay circuit 64. That is, the control signal SW2 fed into the NOR circuit 65 through the delay circuit 64 is delayed compared with the control signal SW2 directly fed into the NOR circuit 65. The NOR circuit 65 performs a NOR operation of the control signals SW2 that are fed into the NOR circuit 65 with the time lag, the NOR circuit 65 inverts the operation result, and the NOR circuit 65 supplies the inverted operation result as the control signal SW11. The delay circuit 64 delays the control signal SW2 when the control signal SW2 is at the ‘L’ level.

Because the control signal generation unit 67 of FIG. 5 controls the time the control signals SW3 and SW9 are fed into the switch element 33 and the gate of the MOS transistor 51, the description is omitted. That is, the control signal SW9 is produced using the signal in which the control signal SW3 is delayed by use the delay circuit 64.

The capacitances C_{cs1} and C_{cs2} of the capacitor elements 50 and 52 included in the discharge unit 57 are determined as follows. The case in which the switch element 32 is switched to the on state to cause the potential at the parasitic capacitor element 30 to make a transition from the voltage VDDR to the voltage VDDR1 is cited by way of example. At this point, the switch element 49 enters the on state by the control signal SW10.

As described above, because VDDR>VDDR1, the switch element 32 enters the on state by the control signal SW2, and the charge corresponding to the voltage (VDDR−VDDR1) is transferred from the parasitic capacitor element 30 to the node N17 through the node N18. This phenomenon is expressed by the following equation (1):

Qₒᵤₜ=Cₒᵤₜ×(VDDR−VDDR1) (1)

Where Qₒᵤₜ is the transferred charge.

The charge accumulated in the capacitor element 52 is expressed by the following equation (2):

Q_{cs2}=C_{cs2}×(VDDR1−VSS) (2)

Where Q_{cs2} is the transferred charge. The voltage Vₛₛ is a potential at the other electrode of the capacitor element 52.

In the cases of Qₒᵤₜ=Q_{cs2}, the charge transferred from the parasitic capacitor element 30 is discharged from the capacitor element 52. That is, the condition is expressed by the following equation (3):

Cₒᵤₜ×(VDDR1−VDDR1)=C_{cs2}×(VDDR1−VSS) (3)

The capacitance C_{cs2} of the capacitor element 52 is expressed as follows from the equation (4):

C_{cs2}=(VDDR−VDDR1)/(VDDR1−V_{SS})×Cₒᵤₜ (4)

When a similar computation is performed on the capacitor element 50, the following equation (5) is obtained:

C_{cs1}=(VDDR1−VDDR2)/(VDDR2−V_{SS})×Cₒᵤₜ (5)

The equation (5) is an equation that is obtained the case in which the switch element 33 is switched to the on state to cause the parasitic capacitor element 30 to make a transition from the voltage VDDR1 to the voltage VDDR2. At this point, both the switch elements 33 and 48 enter the on state by the control signals SW3 and SW8.

A technique except for the technique of providing the capacitor elements 34 to 36 having capacitances sufficiently larger than that of the parasitic capacitor element 30 will be described below. That is, instead of providing the capacitor elements 34 to 36, at the same time as the decoder 2 and the memory cell array 1 are formed, the resistor element, capacitor element, and MOS transistor, which are provided in the decoder 2 and memory cell array 1 are also formed in the high-voltage generation circuit 3. That is, pseudo-circuits of the decoder 2 and memory cell array 1 are provided in the high-voltage generation circuit 3 with respect to the parasitic capacitor element 30 of FIG. 4. In such cases, from the viewpoint of capacitance ratio of the parasitic capacitor element 30, it is necessary to appropriately set the numbers of resistor elements, capacitor elements, and MOS transistors which are used as the pseudo-circuit. The control signals SW1 to SW11 at the ‘L’-level or the ‘H’-level are applied to the switch elements 31 to 33 and 44 to 49 and the MOS transistors 51 and 53. The switch element and the MOS transistor enter the off state when the control signals SW1 to SW11 are set to the ‘L’ level, and the switch element and the MOS transistor enter the on state when the control signals SW1 to SW11 are set to the ‘H’ level. The values of interconnection resistances present in interconnection pathways from the output node N2 to the nodes N8 to N10 are sufficiently larger than the resistance values of the resistor elements 37 to 39.

(Read Operation of Nor-Type Flash Memory)

The read operation of the NOR-type flash memory provided with the high-voltage generation circuit 3 of the first embodiment will be described below by taking the case in which the word line WL0 of FIG. 3 is set to a selection word line as an example. In the read operation of the first embodiment, the memory cell transistor MT that can hold two-bit data is cited by way of example.

A sense amplifier (not illustrated) pre-charges all the bit lines BL. The decoder 2 selects the word line WL0 based on a row address given by the control unit (not illustrated), and the high-voltage generation circuit 3 supplies the read voltage VDDR to the word line WL0 in order to read the ‘3’ data. The voltage VDDR corresponds to the voltage V23 of FIG. 2. When the memory cell transistor MT is in the off state, the bit line BL and the source line SL electrically enter the non-conduction state. That is, it is found that the memory cell transistor MT connected to the selection word line WL holds the ‘3’ data. In such cases, the current is not passed through from the bit line BL to the source line SL. On the other hand, when the memory cell transistor MT connected to the selection word line WL0 is in the on state, the bit line BL and the source line SL enter the conduction state. That is, it is found that the memory cell transistor MT holds one of the ‘0’ data to ‘2’ data. In such cases, the current is passed from the bit line BL to the source line SL. Therefore, the high-voltage generation circuit 3 applies the read voltage VDDR1 to the word line WL0 in order to determine whether the memory cell transistor MT connected to the selection word line WL0 holds one of the ‘0’ data to ‘2’ data. The voltage VDDR1 corresponds to the voltage V12. Similarly, when the memory cell transistor MT is in the off state, it is found that the memory cell transistor MT connected to the selection word line WL holds the ‘2’ data. On the other hand, when the memory cell transistor MT connected to the selection word line WL0 is in the on state, it is found that the memory cell transistor MT holds one of the ‘0’ data and ‘1’ data. The same holds true for the voltage VDDR2 that is output from the high-voltage generation circuit 3 in order to determine whether the memory cell transistor MT holds the ‘0’ data or the ‘1’ data. These pieces of data are collectively read from all the bit lines by the above-described operation.

(Operation of Generation Unit 16 in Reading Data)

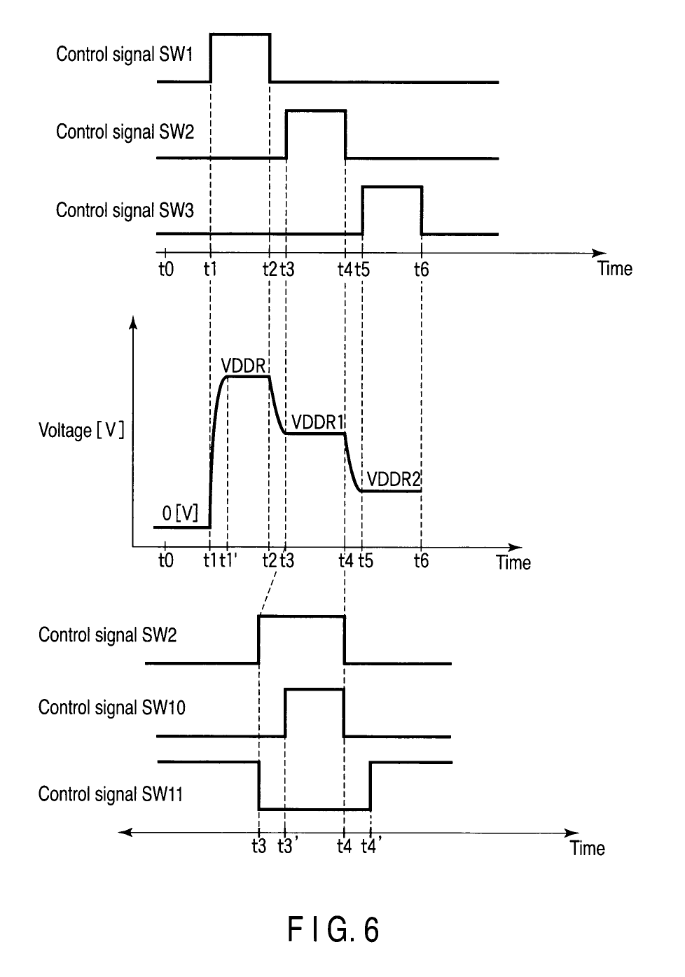

An operation of the generation unit 16 in reading the data will be described with reference to FIGS. 6A to 6C. FIGS. 6A to 6C illustrate a timing chart of the voltage of the control signals and a timing chart of the voltage at the node N2.

FIG. 6A is a timing chart illustrating the control signals SW1 to SW3 supplied to the switch elements 31 to 33. In the timing chart of FIG. 6A, the vertical axis indicates the level of the control signal, that is, the ‘L’ level and ‘H’ level fed into the switch elements, and the horizontal axis indicates time. It is assumed that the switch elements 31 to 33 are in the off state in the case of the ‘L’ level and the switch elements 31 to 33 are in the on state in the case of the ‘H’ level. FIG. 6B is a timing chart illustrating the voltage at the node N2. As illustrated in FIG. 6B, the vertical axis indicates the voltage at the node N2 and the horizontal axis indicates the time. FIG. 6C illustrates a timing chart illustrating control signals SW10 and SW11 fed into the switch elements 49 and 53. As illustrated in FIG. 6C, the vertical axis indicates the control signal level, that is, the ‘L’ level and ‘H’ level fed into the switch elements, and the horizontal axis indicates the time. In the case of the ‘L’ level, the switch element 49 is set to the on state, and the switch element 53 is set to the off state. In the case of the ‘H’ level, the switch element 49 is set to the off state, and the switch element 53 is set to the on state.

At a time t0, in order to make the switch elements 31 to 33 enter the off state, the control unit (not illustrated) sets the control signals SW1 to SW3 to the ‘L’ level. At a time t1, in order to transfer the voltage VDDR to the output node N2, the control unit changes the control signal SW1 supplied to the switch element 31 from the ‘L’ level to the ‘H’ level. At a time t2, in order to end the transfer of the voltage VDDR, the control unit sets the control signal SW1 supplied to the switch element 31 to the ‘L’ level. At a time t3, the control unit sets the control signal SW2 supplied to the switch element 32 to the ‘H’ level. That is, when the switch element 32 is put in the on state, the voltage VDDR output from the output node N2 is switched to the voltage VDDR1. Than, at a time t4, the control unit sets the control signal SW2 supplied to the switch element 32 to the ‘L’ level in order to end the transfer of the voltage VDDR1. At a time t5, the control unit sets the control signal SW3 supplied to the switch element 33 to the ‘H’ level. That is, when the switch element 33 is put in the on state, the voltage VDDR1 output from the output node N2 is switched to the voltage VDDR2. Then, at a time t6, the control unit sets the control signal SW3 supplied to the switch element 33 to the ‘L’ level in order to end the transfer of the voltage VDDR2.

The voltage that the generation unit 16 outputs to the decoder 2 through the output node N2 according to the operations of the control signals SW1 to SW3 supplied to the switch elements 31 to 33 will be described with reference to FIG. 6B. The generation unit 16 switches the voltage to one of the voltages VDDR to VDDR2 from the output node N2 through the decoder 2 if needed, and the generation unit 16 transfers the switched voltage to the memory cell array 1. That is, the potentials transferred to the word line WL are switched according to the operations of the switch elements 31 to 33. FIG. 6B is a timing chart of the read voltage output at the output node N2. The vertical axis indicates the read voltage output from the output node N2, and the horizontal axis indicates the time.

At the time t0, because the switch elements 31 to 33 are in the off state, the potential at the output node N2 becomes 0 V. At the time t1, at the same time as the switch element 31 enters the on state, the potential at the output node N2 rises. The potential at the output node N2 reaches the voltage VDDR at a time t1′. At this point, a relationship of t1<t1′<t2 holds. Up to the time t2, the output node N2 is maintained at the voltage VDDR.

At the time t2, because the switch element 31 is switched from the on state to the off state, the potential at the output node N2 drops from the voltage VDDR. At the time t3, because the switch element 32 enters the on state, the potential at the output node N2 becomes the voltage VDDR1. The output node N2 is maintained at the voltage VDDR1 up to the time t4 at which the switch element 32 is switched from the off state to the on state.

Then, at the time t4, because the switch element 32 is switched from the on state to the off state, the potential at the output node N2 drops from the voltage VDDR1.

At the time t5, the switch element 33 is switched from the off state to the on state. Therefore, the potential at the output node N2 is switched to the voltage VDDR2. The potential at the output node N2 is maintained at the voltage VDDR2 up to the time t6 at which the switch element 33 is switched from the on state to the off state. Then, the potentials of the voltages VDDR to VDDR2 are similarly repeatedly output from the output node N2. Although FIG. 6B illustrates an example of the sequence in which the voltages VDDR to VDDR2 are switched, the first embodiment is not limited to the switching sequence of FIG. 6B.

An operation of the discharge unit 57 will be described with reference to FIG. 6C. At this point, the case in which the switch element 32 is switched to the on state by the control signal SW2 to cause the voltage at the output node N2 to make a transition from the voltage VDDR to the voltage VDDR1 will be described by way of example. That is, the switch element 49 and the MOS transistor 53 are operated in the discharge unit 57. As described above, the control signal SW10 is fed into the switch element 49, the control signal SW11 is fed into the MOS transistor 53, and the switch element 49 and the MOS transistor 53 are put in the on state or the off state by the control signals SW10 and SW11.

FIG. 6C is a timing chart illustrating the operations of the control signals SW2, SW10, and SW11, which are fed into the switch element 32, switch element 49, and MOS transistor 53, respectively. The vertical axis indicates the signal levels of the control signals SW, that is, the ‘L’ level and the ‘H’ level, and the horizontal axis indicates the time. In the case of the ‘L’ level, the switch elements 32 and 49 and the MOS transistor 53 are in the off state. In the case of the ‘H’ level, the switch elements 32 and 49 and the MOS transistor 53 are in the on state.

As described above, at the time t3, the control unit (not illustrated) switches the control signal SW2 from the ‘L’ level to the ‘H’ level in order to switch the switch element 32 from the off state to the on state. That is, the voltage VDDR is transferred from the node N19 to the node N17 that is at the voltage VDDR1. At the same time, that is, at the time t3, the control unit switches the control signal SW11 from the ‘H’ level to the ‘L’ level in order to switch the MOS transistor 53 from the on state to the off state. At a time t3′, the control unit switches the control signal SW10 from the ‘L’ level to the ‘H’ level in order to switch the switch element 49 from the off state to the on state. That is, the node N17 and the capacitor element 52 are electrically connected to each other. Therefore, at the node N17, the capacitor element 52 is charged by the voltage (VDDR−VDDR1). Then, as described above, at the time t4, the control unit sets the control signal SW2 to the ‘L’ level to put the switch element 32 in the off state. At the same time, that is, at the time t4, the control unit switches the control signal SW10 from the ‘H’ level to the ‘L’ level to switch the switch element 49 from the on state to the off state. That is, a non-conduction state is established between the node N17 and the capacitor element 52. Then, at a time t4′, the control unit sets the control signal SW11 to the ‘H’ level to put the MOS transistor 53 in the on state. Therefore, one of the electrodes of the cancel capacitor element 49 is grounded to discharge the charge corresponding to the equation (1) or (2) by which the cancel capacitor element 49 is charged. During the cycle in which the switch element 49 is in the on state, the control unit controls the time the control signals SW10 and 11 are supplied such that the MOS transistor 53 is in the off state.

In FIG. 6C, the operations of the switch element 32 and the switch element 49 and MOS transistor 53 of the discharge unit 57 are described. Because the switch element 33 and the switch element 48 and MOS transistor 51 of the discharge unit 57 are operated at the same timing, the description is omitted.

(Effect of First Embodiment)

The voltage generation circuit of the first embodiment and the semiconductor storage device provided therewith can provide the following effects (1) and (2).

(1) The Operating Speed can be Enhanced (Part 1).

The effect obtained by the high-voltage generation circuit 3 of the first embodiment will be described below compared to a comparative example. A configuration in which only the resistor elements 37 to 39 are provided in the generation unit 16 is considered as the high-voltage generation circuit 3 of the comparative example. That is, the resistor elements 40 to 43, the capacitor elements 34 to 36, and the discharge unit 57 are not provided in the generation unit 16 of the comparative example.

Usually, in the high-voltage generation circuit 3, constant currents are always passed through the resistor elements 37 to 39, the active voltage-dividing circuit 7, and the standby voltage-dividing circuit 10 even in the standby state. For example, in the case of a large current, power consumption is increased in the pump circuit 15. Therefore, it is necessary to reduce the currents passed through the resistor elements 37 to 39 and sensing resistors 10 and 13. That is, it is necessary to increase resistance values of the resistor elements 37 to 39 and sensing resistors 10 and 13 by a certain amount. In such cases, in the comparative example, as described above with reference to FIG. 6, when the voltages VDDR to VDDR2 are changed over time to switch the voltages transferred to the word line WL many times, it might take a long time to set the voltage transferred to the word line WL to the desired voltage. That is, when the voltage transferred to the word line WL is switched from the high read voltage to the low read voltage, it might take a long time to settle at the low voltage. Specifically, it might take a long time to switch the word line WL to the voltage VDDR or voltage VDDR2.

One of the main reasons for this is as follows. In the high-voltage generation circuit 3, when the read voltage transferred from the output node N2 is switched by the data read operation, the charge accumulated in the capacitor element 30 is transferred to one of the capacitor elements 34 to 36, thereby raising the potentials at the capacitor elements 34 and 35. In the high-voltage generation circuit 3 of the comparative example, because the resistor element that discharges the raised voltage includes the resistor elements 37 to 39 having large resistance values, the active voltage-dividing circuit 7, and the standby voltage-dividing circuit 10, the power consumption is lowered in the resistor elements 37 to 39, the active voltage-dividing circuit 7, and the standby voltage-dividing circuit 10. Therefore, it takes a long time to discharge the raised voltage.

Recently, the data read cycle is shortened. That is, because a time to determine the data possessed by the memory cell transistor MT provided in the memory cell array 1 becomes shorter, a cycle for switching the read voltage output from the output node N2 is shortened. Therefore, as the time necessary to discharge the raised voltage is longer than the time necessary to raise the potential at the node N14 by switching the read voltage, the read voltage may deviate from the desired read voltage when the operation for switching the read voltage transferred to the word line WL is repeated many times.

However, the problem can be solved in the high-voltage generation circuit of the first embodiment and the semiconductor storage device provided therewith. That is, the high-voltage generation circuit 3 of the first embodiment can perform a quick data read operation. A detailed description will be made below.

The high-voltage generation circuit 3 of the first embodiment includes the capacitor elements 34 to 36. The capacitor elements 34 to 36 have a capacitance 100 times the capacitance of the parasitic capacitor element 30 connected to the output node N2. That is, even if a charge corresponding to the difference between the voltages of the capacitor element 30 and the capacitor elements 34 to 36 is transferred to the capacitor elements 34 to 36 because of the high voltage applied to the parasitic capacitor element 30, the capacitor elements 34 to 36 have a capacitance that is sufficiently larger than that of the parasitic capacitor element 30, so that the potential at the parasitic capacitor element 30 can quickly make the transition to one of the capacitor elements 34 to 36. That is, the potential at the output node N2 quickly attains the same potential as that at each of the nodes N13 to N15. As described above, because the generation unit 16 has an interconnection resistance that is sufficiently smaller than that of the word line WL, a time constant is increased. Therefore, even if the potentials at the capacitor elements 34 to 36 connected to the nodes N13 to N15 are raised, the desired voltage can be quickly output from the output node N2 and transferred to the word line WL.

Further, because the resistor elements 40 to 43 connected in parallel with the resistor elements 37 to 39 are provided in the generation unit 16 of the high-voltage generation circuit 3 of the first embodiment, the resistance values of the resistor elements 37 to 39 are larger than the resistance values of the resistor elements 37 to 43 connected in parallel. That is, even if the voltages at the nodes N9 and 10 are raised by switching the voltages transferred to the word line WL, the desired voltage can be quickly output from the output node N2 and transferred to the word line WL. Because the resistor elements 37 to 43 have a small resistance value as a whole, the currents passed through the resistor elements 37 to 43 become larger compared with the case in which only the resistor elements 37 to 39 are provided. In other words, this is because the power consumption is increased.

As described above, the switch elements 44 and 45 are put in the on state after the potentials at the nodes N11 and N12 are stabilized, so that the voltages VDDR1 and VDDR2 can stably be output.

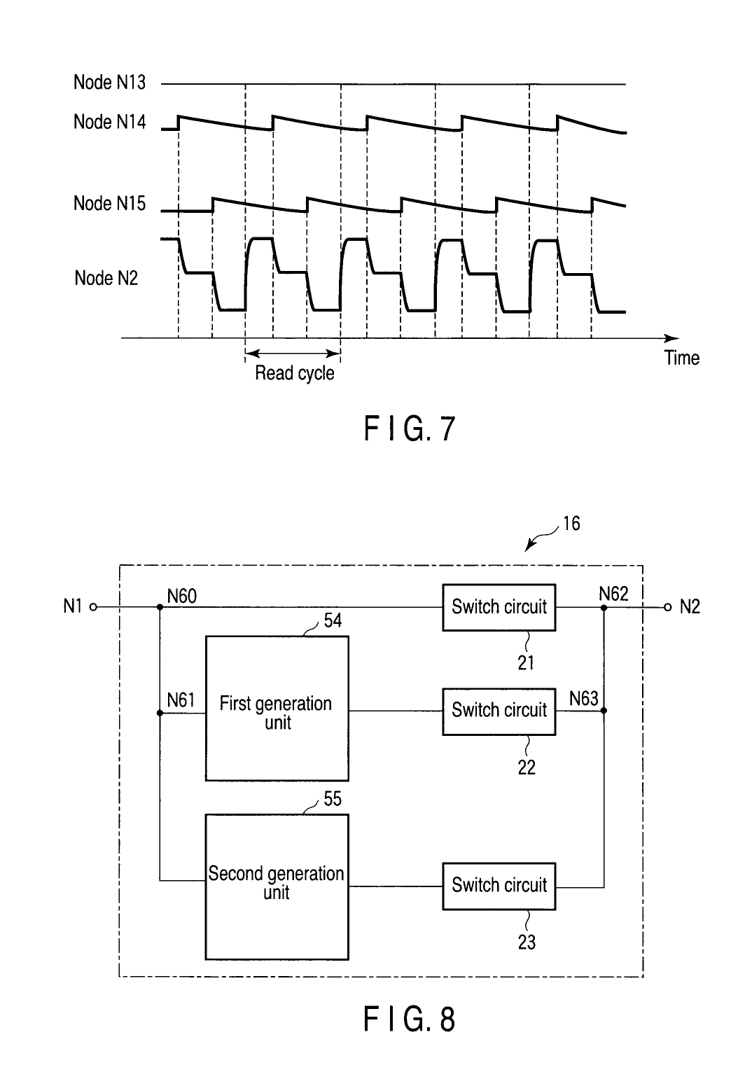

Even if the capacitor elements 34 to 36 and the resistor elements 37 to 40 do not consume all the power, a further effect can be obtained by the discharge of the discharge unit 57. The effect obtained by providing the capacitor elements 34 to 36, the resistor elements 37 to 43, and the discharge unit 57 will be described with reference to FIG. 7. FIG. 7 is a timing chart illustrating the potentials at nodes N13 to N15 and N2 in the generation unit 16. As illustrated in FIG. 7, the vertical axis indicates the potential levels at the nodes, and the horizontal axis indicates the time. As illustrated in FIG. 7, even if the read voltage at the output node N2 is sequentially switched from the voltage VDDR to the voltage VDDR2, the charge corresponding to the voltage (VDDR−VDDR1) is discharged at the node N14, and the read voltage converges on the voltage DDR1 within a data read time. The read time means a cycle in which, for example, one of the ‘0’ data to ‘3’ data held by the memory cell transistor MT is read when the memory cell transistor MT holds the two-bit data. The same holds true for the node N15. Therefore, the data read speed is enhanced because the read voltage is quickly output from the output node N2.

(2) The Operating Speed can be Enhanced (Part 2).

In the voltage generation circuit of the first embodiment and the semiconductor storage device provided therewith, the pump circuit 15 produces the maximum read voltage VDDR transferred to the word line WL, and the pump circuit 15 outputs the read voltage VDDR while the maximum read voltage VDDR is switched to the lower read voltage, for example, the voltage VDDR1 during the data read operation. That is, the maximum read voltage is previously set, and the maximum read voltage is switched to the lower read voltage. Therefore, for example, when the lower read voltage VDDR2 is switched to the higher read voltage VDDR in the data read operation, the problem that a long time is required for the boost operation in order to produce a voltage larger than the voltage VDDR can be avoided in the voltage generation circuit of the first embodiment and the semiconductor storage device provided therewith.

As described above, in the voltage generation circuit of the first embodiment and the semiconductor storage device provided therewith, because the maximum read voltage is produced, it is only necessary to provide the pump circuit 15 that produces the maximum read voltage. That is, because the pump circuit that produces the read voltages VDDR1 and VDDR2 is eliminated, an area of the high-voltage generation circuit 3 and development cost can be reduced, which is advantageous.

### Second Embodiment

A voltage generation circuit according to a second embodiment of the invention and a semiconductor storage device provided therewith will be described below. In the second embodiment, the NOR-type flash memory is described by way of example. In the second embodiment, the configuration of the generation unit 16 of the first embodiment is changed. The generation unit 16 of the second embodiment will be described in detail with reference to FIG. 8. FIG. 8 is a circuit diagram illustrating the generation unit 16 of the second embodiment.

(Generation Unit 16)

As illustrated in FIG. 8, the generation unit 16 of the second embodiment includes a first generation unit 54, a second generation unit 55, and switch circuits 21 to 23. The voltage VDDR is supplied from the node N1 to the first generation unit 54 and second generation unit 55 through nodes N60 and N61. That is, the first generation unit 54 and the second generation unit 55 are connected to the node N1 through the nodes N60 and N61. The voltage VDDR is supplied from the node N1 to the output node N2 through the switch circuit 21 and the node N62.

The first generation unit 54 produces the voltage VDDR1 from the supplied voltage VDDR. The first generation unit 54 outputs the voltage VDDR1 from the output node N2 through the switch circuit 22 and the nodes N63 and node N62.

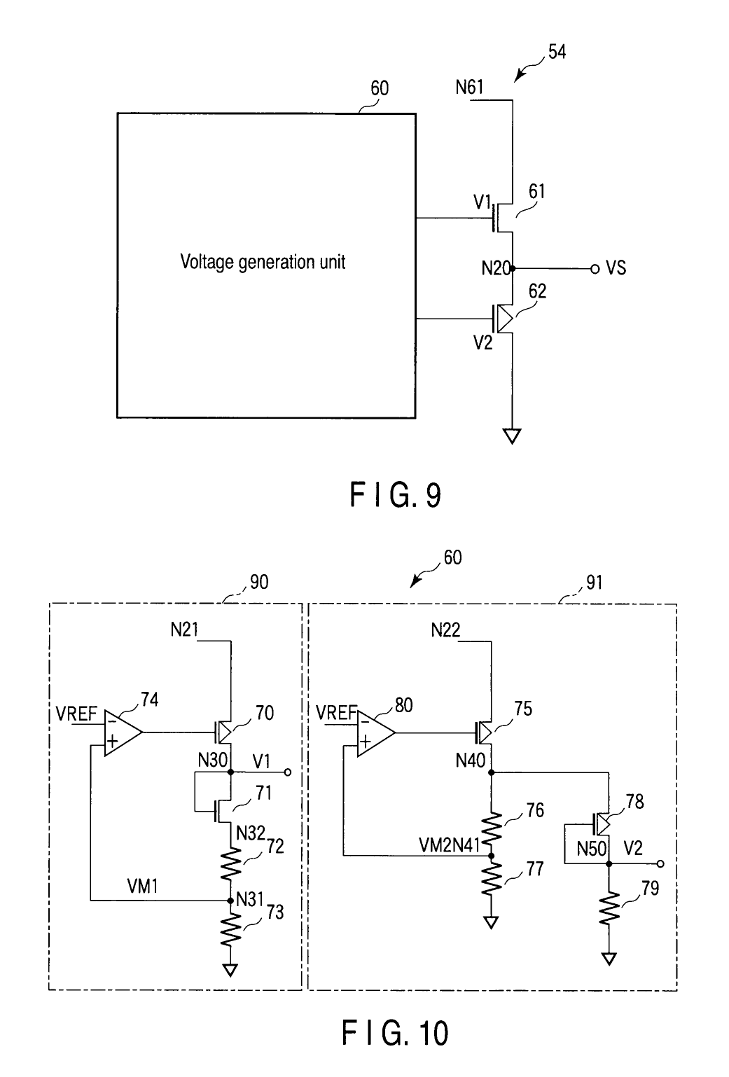

The second generation unit 55 produces the voltage VDDR2 from the supplied voltage VDDR. The second generation unit 55 outputs the voltage VDDR2 from the output node N2 through the switch circuit 23 and the nodes N63 and node N62. That is, the second generation unit 55 is connected to the output node N2 through the nodes N63 and N62. The control unit (not illustrated) puts the switch elements 12 to 14 in the on state or the off state, whereby the generation unit 16 outputs one of the desired read voltage VDDR to VDDR2 from the output node N2. Because the time the switch circuits 21 to 23 are switched is identical to that of the control signals SW1 to SW3 of FIG. 6A, the description is omitted. The switch circuit 21 of FIG. 8 takes one of the on state and the off state in the timing of the ‘L’ level or ‘H’ level of the control signal SW1. The switch circuit 22 takes one of the on state and the off state in the timing of the ‘L’ level or ‘H’ level of the control signal SW2. The switch circuit 23 takes one of the on state and the off state in the timing of the ‘L’ level or ‘H’ level of the control signal SW3. A configuration of the first generation unit 54 that produces the read voltage VDDR1 will be described with reference to FIG. 9.

(First Producing Unit 54)

FIG. 9 is a circuit diagram of the first voltage generation unit 54. Because the second generation unit 55 that produces the read voltage VDDR2 has the same configuration as the first voltage generation unit 54 except for the output voltage, the description is omitted. As illustrated in FIG. 9, the first generation unit 54 of the second embodiment includes a voltage generation unit 60, an n-channel type MOS transistor 61, and a p-channel type MOS transistor 62. It is assumed that Vthn is a threshold of the MOS transistor 61 and Vthp is a threshold of the MOS transistor 62.

The node N61 is connected to a drain end of the MOS transistor 61, a voltage V1 is supplied to the gate of the MOS transistor 61 from the voltage generation unit 60, and a node N20 is connected to a source end of the MOS transistor 61. A voltage VS at the node N20 is output to the output terminal. In the following description, the voltage VS is set to the voltage VDDR1 (voltage VDDR2 in the second generation unit 55). The voltage VDDR is supplied to the node N61. When the voltage V1 supplied from the voltage generation unit 60 is set to a voltage (VS+Vthn) that is higher than the voltage VS by the threshold of the MOS transistor 61, the potential at the node N20 is charged to the voltage VS by the voltage VDDR applied from the node N61. That is, the potential at the node N20 is raised until the MOS transistor 61 cuts off the voltage. When the potential at the node N20 is larger than the voltage VS, the potential at the node N20 becomes larger than the threshold Vthn between the gate and source of the MOS transistor 61, thereby switching the MOS transistor 61 from the on state to the off state. Therefore, the potential at the node N20 enters a floating state with the voltage VS or a value larger than the voltage VS.

The node N20 is connected to the drain end of the MOS transistor 62, a voltage V2 is supplied from the voltage generation circuit 60 to the gate of the MOS transistor 62, and the source end of the MOS transistor 62 is grounded. That is, the source end of the MOS transistor 61 and the drain end of the MOS transistor 62 are commonly connected at the node N20. The voltage V2 supplied from the voltage generation unit 60 is set to a voltage (VS−Vthp) that is lower than the voltage VS at the node N20 by the threshold of the MOS transistor 62. The potential at the node N20 is charged to the voltage VS by the voltage VDDR applied from the node N61, and the voltage between the gate and source of the MOS transistor 62 becomes larger than the threshold Vthp when the potential at the node N20 is larger than the voltage VS, thereby switching the MOS transistor 62 from the off state to the on state. Therefore, the node N20 is grounded through the MOS transistor 62. That is, the potential at the node N20 is switched from the floating state to the conduction state, and the potential at the node N20 starts to drop from the voltage VS or a value larger than the voltage VS. When the potential at the node N20 is smaller than the voltage VS, the potential difference between the gate and source of the MOS transistor 62 becomes smaller than the threshold Vthp of the MOS transistor 62, thereby switching the MOS transistor 62 to the off state. Because the potential difference between the gate and source of the MOS transistor 61 becomes larger than the threshold Vthn of the MOS transistor 61, the MOS transistor 61 is switched to the on state, thereby charging the potential at the node N20 to the voltage VS.

(Configuration Example of Voltage Generating Unit 60)

A configuration of the voltage generation unit 60 will be described in detail with reference to FIG. 10. FIG. 10 is a circuit diagram illustrating the voltage generation unit 60 in detail.

As illustrated in FIG. 10, the voltage generation unit 60 includes a first voltage generation unit 90 and a second voltage generation unit 91. The first voltage generation unit 90 supplies the voltage V1 to the gate of the MOS transistor 61. The second voltage generation unit 91 supplies the voltage V2 to the gate of the MOS transistor 62.

The first voltage generation unit 90 includes a comparator 74, a p-channel type MOS transistor 70, an n-channel type MOS transistor 71, a resistor element 72, and a resistor element 73. One end of a current pathway of the MOS transistor 70 is connected to the node N21, and the other end of the current pathway is connected to one end of a current pathway of the MOS transistor 71 through a node N30. For example, the voltage VDDR is supplied from the node N21. The other end of the current pathway of the MOS transistor 71 is connected to one end of the resistor element 72 through a node N32, and a gate of the MOS transistor 71 is commonly connected to the node N30. That is, the MOS transistor 71 is connected in a diode manner, and the voltage at the node N30 is supplied to the gate. The potential at the node N30 is set to the voltage V1, and the voltage V1 is supplied to the gate of the MOS transistor 71. That is, the potential difference between both ends of the current pathway of the MOS transistor 71 is equal to the potential difference between the other end of the current pathway and the gate of the MOS transistor 71. Therefore, the MOS transistor 71 is operated as a pentode. It is assumed that Vthn(71) is a threshold of the MOS transistor 71. It is assumed that a voltage V0 is a potential at the node N32. The voltage V0 at the node N32 is divided by the resistor elements 72 and 73. That is, the other end of the resistor element 72 is connected to one end of the resistor element 73 through the node N31, and the other end of the resistor element 73 is grounded. The resistor element 72 has a resistance value R2, and the resistor element 73 has a resistance value R1.

For example, the reference voltage VREF produced by the BGR circuit is fed into an inverting input terminal of the comparator 74. A voltage VM1 at the node N31, in which the other end of the resistor element 72 and one end of the resistor element 73 are connected, is supplied to a positive input terminal of the comparator 74. That is, the comparator 74 controls the on state or off state of the MOS transistor 70 such that the reference voltage VREF fed into the comparator 74 and the voltage VM1 at the node N31 match each other. That is, the comparator 74 compares the reference voltage VREF and the voltage VM1, and the comparator 74 outputs the ‘H’-level signal to the gate of the MOS transistor 70 when the reference voltage VREF is less than the voltage VM1. Therefore, the MOS transistor 70 enters the off state, thereby stopping the supply of the voltage from the node N21 to the node N30. The comparator 74 outputs the ‘L’-level signal to the gate of the MOS transistor 70 when the reference voltage VREF is the voltage VM1 or more. Therefore, the MOS transistor 70 enters the on state, the voltage is supplied from the node N21 to the node N30, and the node N30 reaches the voltage V1. When the voltage at the node N30 reaches the voltage V1, because the potential at the node N31 is the voltage VREF, the voltage V0 at the node N32 can be expressed by the following equation (6):

V0=(1+R2/R1)·VREF (6)

As described above, because the MOS transistor 71 has the threshold Vthn(71), the potential at the node N30, that is, the voltage V1 can be expressed by the following equation (7):

V0=(1+R2/R1)·VREF+Vthn(71) (7)

The equations (6) and (7) are satisfied when the resistor elements 72 and 73 have sufficiently large resistance values R1 and R2. The value of the voltage V1 is described later in detail.

The second voltage generation unit 91 will be described below. The second voltage generation unit 91 includes a comparator 80, p-channel type MOS transistors 75 and 78, a resistor element 76, a resistor element 77, and a resistor element 79. One end of a current pathway of the MOS transistor 75 is connected to the node N22, and the other end of the current pathway is connected to one end of a current pathway of the resistor element 76 through a node N40. For example, the voltage VDDR is supplied from the node N22. It is assumed that V0′ is a potential at a node N40. The voltage V0′ at the node N40 is divided by the resistor elements 76 and 77. That is, the other end of the resistor element 76 is connected to one end of the resistor element 77 through a node N41, and the other end of the resistor element 77 is grounded. The resistor element 76 has the resistance value R2, and the resistor element 77 has the resistance value R1.

For example, the reference voltage VREF produced by the BGR circuit is fed into an inverting input terminal of the comparator 80. A voltage VM2 at the node N41, in which the other end of the resistor element 76 and one end of the resistor element 77 are connected, is supplied to a positive input terminal of the comparator 80. That is, the comparator 80 controls the on state or off state of the MOS transistor 75 such that the reference voltage VREF fed into the comparator 80 and the voltage VM2 at the node N41 are matched with each other. That is, the comparator 80 compares the reference voltage VREF and the voltage VM2, and the comparator 80 outputs the ‘H’-level signal to the gate of the MOS transistor 75 when the reference voltage VREF is less than the voltage VM2. Therefore, the MOS transistor 75 enters the off state, thereby stopping the supply of the voltage from the node N22 to the node N40. The comparator 80 outputs the ‘L’-level signal to the gate of the MOS transistor 75 when the reference voltage VREF is the voltage VM2 or more. Therefore, the MOS transistor 75 enters the on state, the voltage is supplied from the node N22 to the node N40, and the node N40 reaches the voltage V0. When the voltage at the node N40 reaches the voltage V0', because the voltage VM2 at the node N41 becomes equal to the voltage VREF, the voltage V0' at the node N40 can be expressed by the following equation (8):

V0′=(1+R2/R1)·VREF (8)

One end of a current pathway of the MOS transistor 78 is connected to the node N40, and the other end of the current pathway is connected to one end of a resist element 79 through a node N50, and the gate of the MOS transistor 78 is connected to the node N50. That is, the MOS transistor 78 is connected in the diode manner, and the voltage at the node N50 is supplied to the gate. At this point, the MOS transistor 78 is operated as a pentode. That is, the potential difference between both ends of the current pathway of the MOS transistor 78 is equal to the potential difference between the other end of the current pathway and the gate of the MOS transistor 78, and the other end of the resistor element 79 is grounded. Assuming that a voltage V2 is a potential at the node N50, the voltage V2 is supplied to the gate of the MOS transistor 78. When the node N40 reaches the voltage V0′, the voltage V2 at the node N50 can be expressed by the following equation (9):

V2=(1+R2/R1)·VREF−Vthp(78) (9)

That is, the potential at the node N50 reaches the voltage expressed by the equation (9). The numeral Vthp(78) designates a threshold of the MOS transistor 78. The voltages VM1 and VM2 are simply referred to as voltage VM unless distinguished from each other.

The equations (8) and (9) are satisfied when the resistor element 79 has a sufficiently large resistance value R3. The value of the voltage V2 is described later in detail.

In addition to the configuration of FIG. 10, the voltage generation unit 60 of FIG. 9 may adopt the following configuration. A configuration in which the voltages V1 and V2 are output like the configuration of FIG. 10 will be described with reference to FIG. 11. FIG. 11 is a circuit diagram illustrating the voltage generation circuit 60 in detail, and also illustrates the voltage generation circuit 60 in which the first voltage generation unit 90 and the second voltage generation unit 91 of FIG. 10 are combined. That is, the comparator 74, the MOS transistors 70 and 71, and the resistor elements 72 and 73 are replaced with a comparator 97, MOS transistors 93 and 94, and resistor elements 95 and 96 in the first voltage generation unit 90 of FIG. 10, and the MOS transistor 78 and the resistor element 79 are replaced with a MOS transistor 98 and a resistor element 99 in the second voltage generation unit 91. In FIG. 11, the voltage VDDR is supplied from the node N51, the voltage V1 is output from the node N52, the potential at the node N53 is set to the voltage V0, the potential at the node N54 is set to the voltage VM1, and the voltage V2 is output from the node N55. The resistor elements 96, 95, and 99 have the resistance values R1, R2, and R3, and the MOS transistors 71 and 78 have the thresholds Vthn(71) and Vthp(78). The following description will be made using the voltage generation circuit 60 of FIG. 10.

(Detailed Value of Voltages V1 and V2)

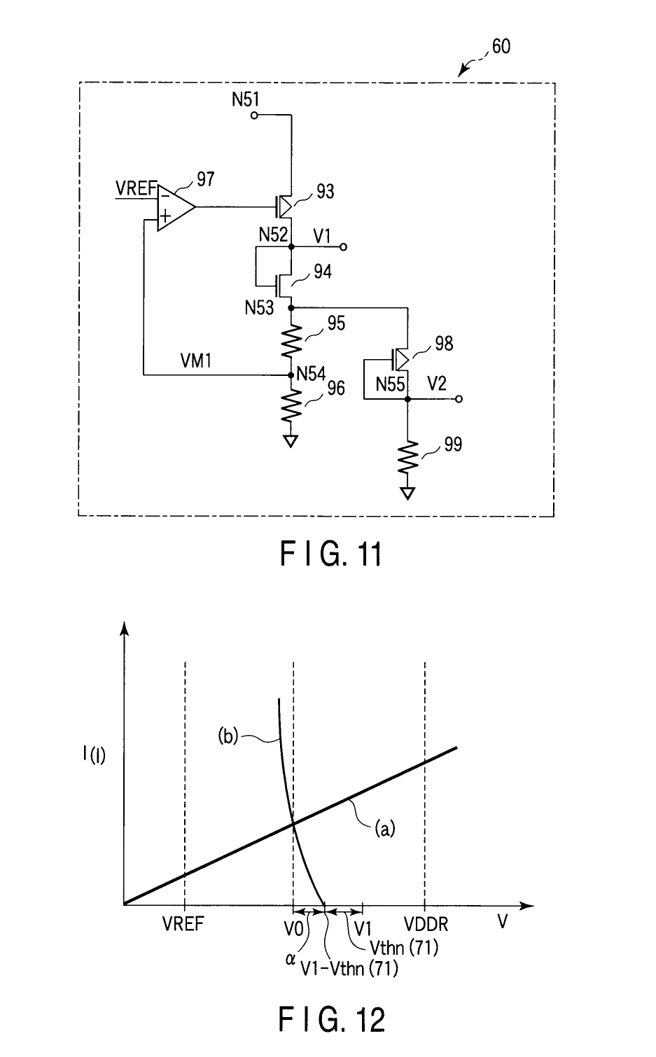

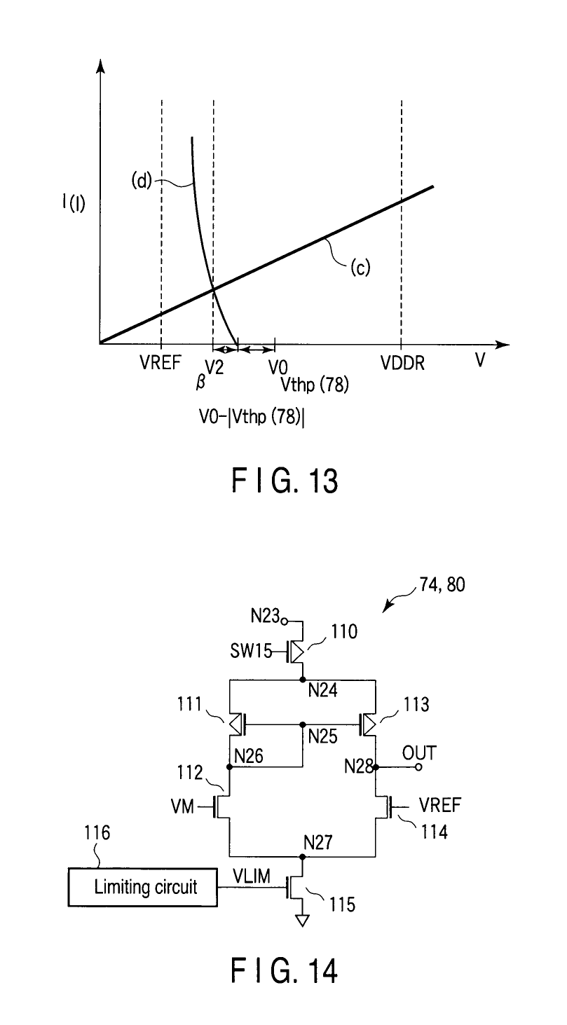

The values of the voltages V1 and V2 output from the first voltage generation unit 90 and second voltage generation unit 91 will be described in detail with reference to FIGS. 12 and 13. FIGS. 12 and 13 illustrate a V-I characteristic of the first voltage generation unit 90 and a V-I characteristic of the second voltage generation unit 91.

Referring to FIG. 12, the vertical axis indicates a current I_{(I)} passed through the MOS transistor 70, node N30, MOS transistor 71, resistor element 72, and resistor element 73, and the horizontal axis indicates the potential at the node N32. That is, the voltage VREF, the voltage V0, the voltage (V1−Vthn(71)), and the voltage V1 are obtained in ascending order of voltage on the horizontal axis. A straight line designated by the letter A of FIG. 12 is a load line (hereinafter sometimes referred to as A line) of the resistor elements 72 and 73, and a curved line (hereinafter sometimes referred to as B line) designated by the letter B is the current I_{(I)}.

The load line has a gradient of 1/(R1+R2), and the gradient of the load line changes according to the resistance values R1 and R2.

As illustrated in FIG. 12, the current I_{(I)} is passed through a channel region of the MOS transistor 71 until the potential at the other end of the current pathway of the MOS transistor 71 becomes equal to a value at which the threshold is subtracted from the potential at the gate of the MOS transistor 71. That is, the MOS transistor 71 is maintained in the on state until the potential at the other end of the current pathway of the MOS transistor 71 becomes equal to the voltage (V1−Vthn(71)). Because the MOS transistor 71 is connected in the diode manner, the potential difference between both ends of the current pathway of the MOS transistor 71 is equal to the potential difference between the other end of the current pathway and the potential at the gate of the MOS transistor 71. That is, as described above, the MOS transistor 71 is operated as a pentode. When the potential at the other end of the current pathway of the MOS transistor 71 exceeds the voltage (V1−Vthn(71)), the potential difference between the gate of the MOS transistor 71 and the other end of the current pathway becomes smaller than the threshold of the MOS transistor 71, thereby switching the MOS transistor 71 to the off state. That is, the current I_{(I)} is not passed. It is assumed that the MOS transistors 71 and 61 have the same channel length. It is also assumed that the MOS transistor 61 has a channel width W1′ while the MOS transistor 71 has a channel width W2. The current I_{(I)} passed through the channel region of the MOS transistor 61 becomes current I_{(I)}·W1/W1′.

The current I_{(I)} passed through one end of the resistor element 72, that is, the potential at the node N32 and the resistor elements 72 and 73 attains a value of an intersection of the B line with the A line. The voltage at the intersection is also the voltage at the other end of the current pathway of the MOS transistor 71. That is, the threshold Vthn(71) of the MOS transistor 71 is subtracted from the voltage V1, and the voltage α is further subtracted from the obtained difference, thereby obtaining the voltage V0 at the intersection of the V-I characteristic with the load line. As the resistance values R1 and R2 are increased, the gradient of the load line is decreased to bring the voltage V0 at the node N32 close to the voltage (V1−Vthn(71)), thereby decreasing the voltage α. The voltage α is changed by the resistance values of the resistor elements 72 and 73, that is, the voltage α is decreased as the resistance values of the resistor elements 71 and 73 are increased. On the other hand, the voltage α is increased as the resistance values of the resistor elements 71 and 73 are decreased. Thus, the voltage V1 is obtained by adding the voltage (Vthn(71)+α) to the potential at the node N32. The gradient of the B line is changed by the channel width of the MOS transistor 71.

The value of the voltage V2 will be described with reference to FIG. 13 in detail. Referring to FIG. 13, the vertical axis indicates a current I_{(II)} passed through the MOS transistor 75, node N40, MOS transistor 78, node N50, and resistor element 79, and the horizontal axis indicates the potential at the node N55. That is, the voltage VREF, the voltage V2, the voltage (V0−Vthp(78)), and the voltage V0 are obtained in ascending order of voltage on the horizontal axis.

A straight line designated by the letter C of FIG. 13 is a load line (hereinafter sometimes referred to as C line) of the resistor elements 79, and a curved line (hereinafter sometimes referred to as (d) line) designated by a (d) line is the current I_{(II)}.

The load line has a gradient of 1/R3, and the gradient of the load line changes according to the resistance value R3.

As illustrated in FIG. 13, the current I_{(II)} (hereinafter sometimes referred to as (d) line) is passed through a channel region of the MOS transistor 78 until the potential at the other end of the current pathway of the MOS transistor 78, that is, the potential at the gate becomes equal to the potential in which the threshold is subtracted from the potential at one end of the MOS transistor 78. That is, the MOS transistor 78 is maintained in the on state until the potential at the other end of the current pathway of the MOS transistor 78 becomes equal to the voltage (V0−Vthp(78)). Because the MOS transistor 78 is connected in the diode manner, the potential difference between both ends of the current pathway of the MOS transistor 78 is equal to the potential difference between the other end of the current pathway and the potential at the gate of the MOS transistor 78. That is, the MOS transistor 78 is operated as the pentode. When the potential at the other end of the current pathway of the MOS transistor 78 exceeds the voltage (V0−Vthp(78)), the potential difference between the gate of the MOS transistor 78 and one end of the current pathway becomes larger than the threshold of the MOS transistor 78, thereby switching the MOS transistor 78 to the off state. That is, the current I_{(II)} is not passed. It is assumed that the MOS transistors 78 and 62 have the same channel length. It is also assumed that the MOS transistor 62 has a channel width W2′ while the MOS transistor 78 has the channel width W2. A current I_{(II′)} passed through the channel region of the MOS transistor 62 becomes current I_{(II)}·W2/W2′.

The current I_{(II)} passed through one end of the resistor element 79, that is, the potential at the node N50 and the resistor element 79 attains a value of an intersection of the (d) line with the C line. The voltage at the intersection is also the voltage at the other end of the current pathway of the MOS transistor 78. That is, the threshold Vthn(79) of the MOS transistor 78 is subtracted from the voltage V0′, and the voltage β is further subtracted from the obtained difference, thereby obtaining the voltage V2 at the intersection of the V-I characteristic with the load line.

As the resistance value R3 is increased, the gradient of the load line is decreased to bring the voltage V2 at the node N50 close to the voltage (V0−|Vthp(78)|), thereby decreasing the voltage β. The voltage β is increased as the resistance values of the resistor elements 71 and 73 are decreased. That is, the voltage β is changed by the resistance value R3 of the resistor element 79. Thus, the voltage V2 is obtained by subtracting the voltage (Vthp(78)+β) from the potential at the node N40. The gradient of the (d) line is increased with increasing channel width W of the MOS transistor 78.

(Configuration Example of Comparator 74 and 80)

A configuration example of the comparators 74 and 80 included in the first and second voltage generation units 90 and 91 will be described in detail with reference to FIG. 14. Because the comparators 74 and 80 have the same configuration, only the comparator 74 will be described below. As described above, the voltages VM1 and VM2 supplied to the positive input terminals of the comparators 74 and 80 are simply referred to as voltage VM. As illustrated in FIG. 14, the comparator 74 includes p-channel type MOS transistors 110, 111, and 113, n-channel type MOS transistors 112, 114, and 115, and a limiting circuit 116.

The node N23 is connected to one end of a current pathway of the MOS transistor 110, the other end of the current pathway is connected to one end of a current pathway of the MOS transistor 111 and one end of a current pathway of the MOS transistor 113 through a node N24, and the control signal SW15 is fed into the gate. For example, the voltage VDDR is supplied from the node N23. The other end of the current pathway of the MOS transistor 111 is connected to one end of a current pathway of the MOS transistor 112 through a node N26, and a gate of the MOS transistor 111 is connected to a node N25. The other end of the current pathway of the MOS transistor 112 is connected to a node N27, and the voltage VM is fed into the gate of the MOS transistor 112. The other end of the MOS transistor 113 is connected to one end of a current pathway of the MOS transistor 114 through a node N28, and the node N25 is connected to the gate of the MOS transistor 113. That is, the gates of the MOS transistors 113 and 114 are commonly connected. The node N28 is connected to the gate of the MOS transistor 70 through the output terminal (designated by the letter OUT). The node N27 is connected to the other end of the current pathway of the MOS transistor 114, and the reference voltage VREF is fed into the gate of the MOS transistor 114. One end of a current pathway of the MOS transistor 115 is connected to the node N27, the other end of the current pathway of the MOS transistor 115 is grounded, and a voltage VLIM is fed into the gate of the MOS transistor 115 from the limiting circuit 116. A detailed configuration example of the limiting circuit 116 is described later. The operation of the comparator 74 is described below. Because the comparator 80 is operated in the same way as the comparator 74, the description is omitted.

(Operation of Comparator 74)

An operation for comparing the voltage VM and the reference voltage VREF, performed by the comparator 74, will be described below. It is assumed that the ‘L’-level signal is fed as the control signal SW15 into the gate of the MOS transistor 110, and it is assumed that the ‘H’-level signal is fed as the voltage VLIM into the gate of the MOS transistor 115 from the limiting circuit 116. That is, the MOS transistors 110 and 115 are set to the on state. In cases where the potential at the node N28 is raised, it is assumed that the ‘H’-level signal is fed into the gate of the MOS transistor 70 from the output terminal. On the other hand, in cases where the potential at the node N28 is decreased toward 0 V, it is assumed that the ‘L’-level signal is fed into the gate of the MOS transistor 70 from the output terminal.

(1) In the Case of VM<VREF

Because VM<VREF, it is assumed that the MOS transistor 112 is in the off state while the MOS transistor 114 is in the on state. At this point, because the MOS transistor 112 is in the off state, the nodes N26 and N25 are in the floating state. Because the MOS transistor 112 is not in the on state, the nodes N26 and N25 are not grounded by the MOS transistor 115. Therefore, the potentials at the nodes N26 and N25 are maintained higher than 0 V, and thereby maintaining the MOS transistors 111 and 113 in the off state. As described above, because the MOS transistor 114 is in the on state, the node N28, the MOS transistor 114, the node N27, and the MOS transistor 115 are electrically connected. That is, because the potential at the node N28 is decreased toward 0 V, the ‘L’-level signal is output from the output terminal, thereby maintaining the MOS transistor 70 (not illustrated) in the on state. The potential at the node N31 is charged until VM=VREF.

(2) In the Case of VM>VREF

Because VM>VREF, it is assumed that the MOS transistor 112 is in the on state while the MOS transistor 114 is in the off state. At this point, because the MOS transistor 112 is in the on state, the nodes N25 and N26 and the MOS transistors 112 and 115 are electrically connected. That is, because the nodes N25 and N26 are grounded, the potentials at the nodes N25 and N26 become 0 V, thereby switching the MOS transistors 111 and 113 to the on state. On the other hand, because the MOS transistor 114 is in the off state, the node N23, the ‘H’-level signal is output from the output terminal through the node N23, the MOS transistor 110, the node N24, the MOS transistor 113, and the node N28, and thereby switching the MOS transistor 70 (not illustrated) to the off state. The potential at the node N31 is discharged until the voltage VM becomes equal to the reference voltage VREF from the state of VM>VREF.

(Configuration Example of Limiting Circuit 116)

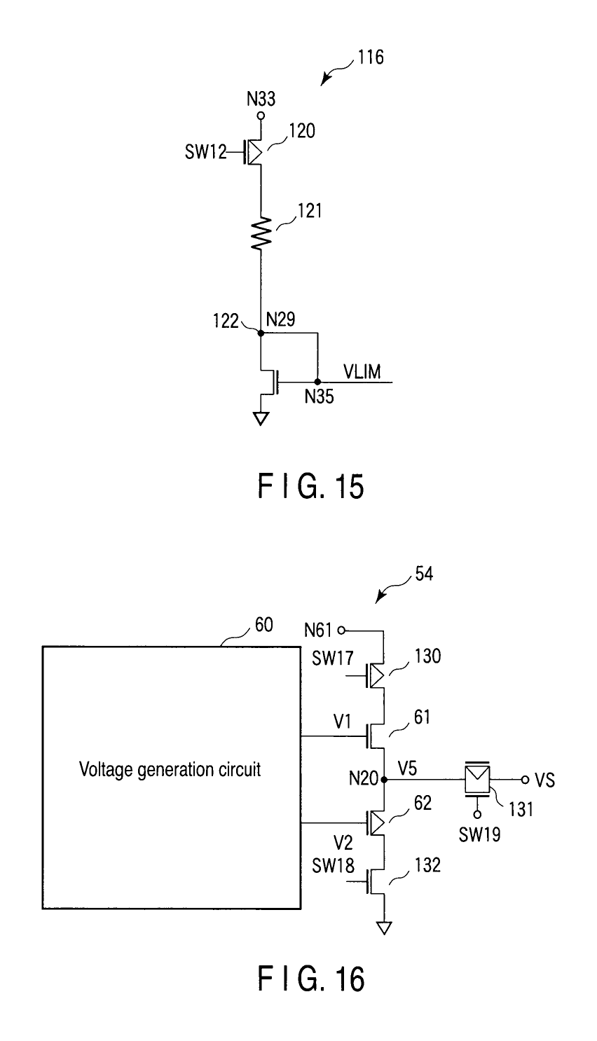

A configuration example of the limiting circuit 116 will be described with reference to FIG. 15. FIG. 15 is a circuit diagram of the limiting circuit 116. As illustrated in FIG. 15, the limiting circuit 116 includes MOS transistors 120 and 122 and a resistor element 121. It is assumed that the resistor element 121 has a resistance value R4.

One end of a current pathway of the MOS transistor 120 is connected to the node N33, the other end of the current pathway is connected to one end of the resistor element 121, and the control signal SW12 is fed into the gate of the MOS transistor 120. The other end of the resistor element 121 is connected to one end of a current pathway of the MOS transistor 122 through the node N29. The other end of the current pathway of the MOS transistor 122 is grounded, and a node N35 is connected to the gate of the MOS transistor 122. The nodes N35 and N29 are connected to each other. That is, the node N35 is connected to the other end of the resistor element 121 and one end of the current pathway of the MOS transistor 122 through the node N29. For example, a voltage VDD is fed into the node N33 from an external power supply. When a resistance of the MOS transistor 120 is sufficiently decreased, a current I_{(R4)} passed through the resistor element 121 can be expressed by the following equation (10):

I_{(R4)}=(VDD−Vthn(122))/R4 (10)

Where Vthn(122) is a threshold of the MOS transistor 122.

Because a mirror circuit is formed by the MOS transistor 122 and the MOS transistor 115 (not illustrated), the current I_{(R4)} is passed through the channel region of the MOS transistor 115. The current I_{(R4)} passed through the channel regions of the MOS transistors 122 and 115 can be controlled according to the voltage VLIM fed into the gates of the MOS transistors 122 and 115. The voltage VLIM is a voltage (VDD−Vthn(122)). The MOS transistor 120 is switched to the on state or the off state by the control signal SW12, thereby controlling the current I_{(R4)} passed through the MOS transistor 115. The potential difference between the potential at the nodes N29 and N35 of the MOS transistor 122 and the other end of the current pathway of the MOS transistor 122 is a value in which the voltage α is added to the threshold of the MOS transistor 122 like the MOS transistors 70 and 78 of FIG. 9.

(Effect of Second Embodiment)

In the voltage generation circuit of the second embodiment and the semiconductor storage device provided therewith, the following effect (3) can be obtained.

(3) The Operating Reliability can be Improved (Part 1).

The effect obtained by the second embodiment will be described below compared to a comparative example. The case in which the channel width W of the MOS transistor 71 in the first voltage generation unit 90 is decreased while the resistance values R2 and R1 of the resistor elements 72 and 73 are sufficiently increased will be described as a comparative example of the second embodiment. In the comparative example, the gradient of the B line of FIG. 12 is decreased, and the gradient of the load line indicated by the A line is decreased. Therefore, the current I_{(I)} passed through the channel region of the MOS transistor 71 is decreased, and the change in current corresponding to the change in voltage is decreased. When the current passed through the channel region of the MOS transistor 71 is rapidly changed, the change in voltage is increased in the MOS transistor 71. That is, the value of the current I_{(I)} is changed to increase the range of the change in voltage α, whereby the voltage V0 becomes unstable. The same holds true for the second voltage generation unit 91.

On the other hand, in the second embodiment, the channel width W of the MOS transistor 71 is increased to increase the gradient of the B line of FIG. 12, that is, the change in current corresponding to the change in voltage is increased on the B line. Further, a constant current I_{(I)} is passed through the channel region of the MOS transistor 71 by adjusting the resistance values R2 and R1 of the resistor elements 72 and 73, that is, the voltage α is made larger than at least 0 V. Specifically, the voltage α is adjusted such that the current I_{(I)} of, for example, about 10 μA is passed through the channel region of the MOS transistor 71. That is, in order to pass the current I_{(I)} of, for example, about 10 μA, the values of the resistor elements 72 and 73 are adjusted while the channel width W of the MOS transistor 71 is increased. Therefore, even if the current I_{(I)} passed through the channel region of the MOS transistor 71 rapidly changes, the change in voltage is decreased in the MOS transistor 71, and the voltage V0 is stabilized according to the change in current, so that the voltage V1 can stably be output. A similar effect can be obtained in the second voltage generation unit 91. That is, the voltage β is a value larger than at least 0 V, and the channel width W of the MOS transistor 78 and the value of the resistor element 79 are adjusted according to the current I_{(II)} passed through the channel region of the MOS transistor 78.

### Third Embodiment

A voltage generation circuit according to a third embodiment of the invention and a semiconductor storage device provided therewith will be described below. In the third embodiment, the NOR-type flash memory is also described by way of example. In the third embodiment, the configuration of the first generation unit 54 of FIGS. 8 and 9 of the second embodiment is changed. Only a configuration that is different from that of the first generation unit 54 of the second embodiment will be described with reference to FIG. 16. FIG. 16 is a block diagram of the first generation unit 54. Referring to FIG. 16, the first generation unit 54 of the third embodiment further includes a p-channel type MOS transistor 130, an n-channel type MOS transistor 132, and a switch element 131.

(First Producing Unit 54)

The MOS transistor 130 is provided between one end of the current pathway of the MOS transistor 61 and the node N61, the MOS transistor 132 is provided between the other end of the current pathway of the MOS transistor 62 and the ground (0 V), and the switch element 131 is provided between the node N20 and the output terminal. That is, the node N61 is connected to one end of a current pathway of the MOS transistor 130, one end of the current pathway of the MOS transistor 61 is connected to the other end of the current pathway of the MOS transistor 130, and a control signal SW17 is fed into the gate of the MOS transistor 130. The other end of the current pathway of the MOS transistor 62 is connected to one end of a current pathway of the MOS transistor 132, the other end of the current pathway of the MOS transistor 132 is grounded, and a control signal SW18 is fed into the gate of the MOS transistor 132. One end of the switch element 131 is connected to the node N20, and the other end of the MOS transistor 131 is connected to the output terminal. A control signal SW19 is fed into the switch element 131. The switch element 131 takes one of the on state and the off state by the control signal SW19. The control unit (not illustrated) controls the time the control signals SW17 to SW19 are fed. The time the control signals SW17 to SW19 are fed will be described below. Because other configurations are identical to those of the first generation unit 54 of the second embodiment, description is omitted.

(Control Signals Sw17 to Sw19)

The operation performed by the first generation unit 54 in response to the control signals SW17 to SW19 is divided into the case in which the first generation unit 54 is switched from a non-operating state to an operating state to output the voltage VS from the output terminal (hereinafter referred to as Case (I)) and the case in which the first generation unit 54 is switched from the operating state to the non-operating state to stop the voltage VS output from the output terminal (hereinafter referred to as Case (II)).

(I) The Case in which the First Generation Unit 54 outputs the Voltage VS from the Output Terminal

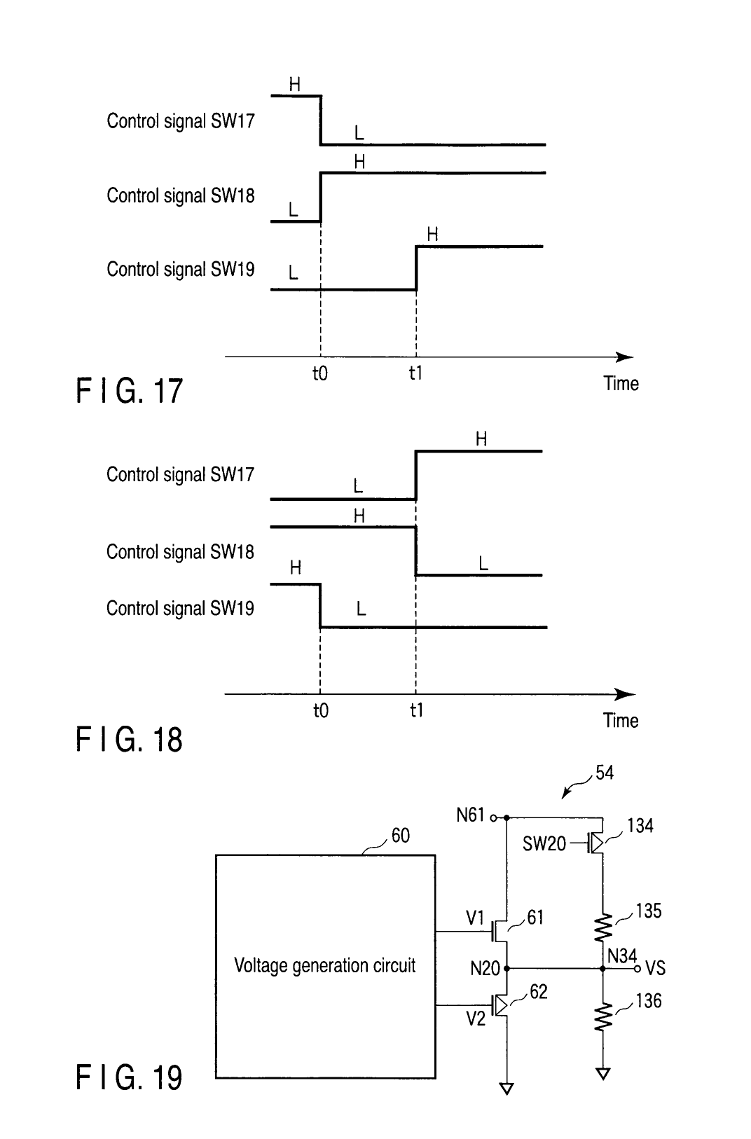

Case (I) will be described with reference to FIG. 17. FIG. 17 is a timing chart of the control signals SW17 to SW19. In order to set the potential at the node N20 to the voltage VS, at the time t0, the control unit (not illustrated) changes the control signal SW17 from the ‘H’ level to the ‘L’ level to switch the MOS transistor 130 to the on state. At the time t0, the control unit changes the control signal SW18 from the ‘L’ level to the ‘H’ level to switch the MOS transistor 132 to the on state. Because the MOS transistors 130 and 132 are switched from the off state to the on state, the node N20 is charged from the node N61. Then, in order to output the voltage VS at the node N20 to the output terminal, at the time t1, the control unit changes the control signal SW19 from the ‘L’ level to the ‘H’ level to switch the switch element 131 to the on state. The MOS transistor 131 is switched from the off state to the on state, thereby outputting the voltage VS at the node N20 to the output terminal.

(II) The Case in which the First Generation Unit 54 stops the Voltage VS

Case (II) will be described with reference to FIG. 18. FIG. 18 is a timing chart of the control signals SW17 to SW19. As illustrated in FIG. 18, in order to stop the output of the voltage VS, at the time t0, the control unit changes the control signal SW19 from the ‘H’ level to the ‘L’ level to switch the switch element 131 to the off state. Therefore, because the switch element 131 is switched from the on state to the off state, the output of the voltage VS at the node N20 from the output terminal is stopped. Then, in order to stop the charge of the node N20 from the node N61, at the time t1, the control unit changes the control signal SW17 from the ‘L’ level to the ‘H’ level to switch the MOS transistor 130 to the off state. At the time t1, the control unit changes the control signal SW18 from the ‘L’ level to the ‘H’ level to switch the MOS transistor 132 to the off state. Therefore, the MOS transistors 130 and 132 are switched from the on state to the off state.

(Effect of the Third Embodiment)

In the voltage generation circuit of the third embodiment and the semiconductor storage device provided therewith, the following effects (4) and (5) are obtained in addition to the effect (3).

(4) The Operating Reliability can be Improved (Part 2).

The voltage VS output from the output terminal of the first voltage generation unit 54 can be stably maintained in the high-voltage generation circuit 3 of the third embodiment. Because a similar effect is obtained for the second voltage generation unit 55, the description is omitted. The first voltage generation unit 54 will be described in detail.

Even if the output from the voltage generation unit 60 is fixed to the voltages V1 and V2, the MOS transistors 130 and 132 and the switch element 131 are switched to the on state or the off state at the timing shown in FIG. 16 in response to the control signal SW17 to SW19, so that the voltage VS can be output to the output terminal after the node N20 is sufficiently charged from the node N61 to stabilize the node N20 in the voltage VS. That is, the MOS transistors 130 and 132 are switched to the on state by the control signals SW17 and SW18 before the switch element 131 is switched to the on state, which allows the node N20 to be stabilized at the voltage VS. Therefore, the generation unit 16 can stably output the voltage VS from the output terminal.

The same holds true for the case in which the voltage VS from the output terminal is stopped. That is, the MOS transistors 130 and 132 and the switch element 131 are switched to the on state or the off state at the timing shown in FIG. 18 in response to the control signal SW17 to SW19, so that the output of the voltage VS from the output terminal can be stopped while the voltage VS at the node N20 is stably maintained.

(5) The Operating Reliability can be Improved (Part 3).

The effect obtained in the high-voltage generation circuit of the third embodiment and the semiconductor storage device provided therewith will be described below compared to a comparative example in which the MOS transistors 130 and 132 are not provided in the first voltage generation unit 54. In the first voltage generation unit 54 of the comparative example, when the MOS transistors 130 and 132 are not provided, even if the first voltage generation unit 54 is in the standby state, a standby current is passed through the node N61, the MOS transistor 61, the node N20, and the MOS transistor 62. In such cases, it is necessary that the pump circuit 15 perform sufficient pumping to pass the standby current through the generation unit 16 using the internal power supply VDD and the voltage VSS (0 V). Therefore, the power consumption is increased in the NOR-type flash memory by the pumping of the pump circuit 15.

However, this problem can be solved by use of the high-voltage generation circuit of the third embodiment and the semiconductor storage device provided therewith. That is, in the high-voltage generation circuit 3 of the third embodiment, the first voltage generation unit 54 includes the MOS transistors 130 and 132. Therefore, when the generation unit 16 is in the standby state, the MOS transistors 130 and 132 are set to the off state by the control signals SW17 and SW18 to stop the standby current passed through the first voltage generation unit 54, so that an increase in the power consumption caused by the pumping can be prevented.

(Modification)

The voltage generation circuit 3 according to a modification of the third embodiment will be described with reference to FIG. 19. The configurations of the first voltage generation units 54 and 55 of the third embodiment are replaced in the modification of the third embodiment. Only a configuration that is different from that of the first voltage generation unit 54 of the second embodiment will be described below. The same constituent is designated by the same numeral. Because the second voltage generation unit 55 has the same configuration as the first voltage generation unit 54, the description is omitted.

The first voltage generation unit 54 of the modification of the third embodiment includes a MOS transistor 134, a resistor element 135, and a resistor element 136 in addition to the configuration of the first voltage generation unit 54 of FIG. 9. One end of a current pathway of the MOS transistor 134 is connected to the node N61 and one end of the current pathway of the MOS transistor 61, the other end of the current pathway of the MOS transistor 134 is connected to one end of a current pathway of the resistor element 135, and a control signal SW20 is fed into the gate of the MOS transistor 134. The other end of the resistor element 135 is connected to one end of the resistor element 136 through the node N34. The other end of the resistor element 136 is grounded. The node N34 is connected to the node N20 and the output terminal. The resistor elements 135 and 136 have resistance values R5 and R6. The resistance values R5 and R6 are sufficiently large such that the potential at the node N34 becomes the voltage VS due to a current comparable with the standby current passed through the resistor elements 135 and 136.

(Effect of Modification of Third Embodiment)

In the high-voltage generation circuit of the modification of the third embodiment and the semiconductor storage device provided therewith, the following effect can be obtained in addition to the effects (3) to (5).

(6) The Operating Reliability can be Improved (Part 4).

The effect obtained in the modification of the third embodiment will be described below compared to a comparative example in which the MOS transistor 134 and the resistor elements 135 and 136 are not provided in the first voltage generation unit 54 of FIG. 19. In the comparative example, the same constituent is designated by the same numeral. When the first voltage generation unit 54 of the comparative example is in the standby state, the standby current is passed through the node N61, and the MOS transistors 61 and 62. That is, the first voltage generation unit 54 is in the state in which the voltage VS is not output. When the state in which the voltage VS is not output is continued for a long time, sometimes the voltage VS cannot be maintained at the node N20. That is, the potential at the node N20 deviates from the voltage VS. When the first voltage generation unit 54 makes a transition from the standby state to the active state, a voltage deviating from the desired voltage VS is output from the output terminal.

However, the problem can be solved by the high-voltage generation circuit of the modification of the third embodiment and the semiconductor storage device provided therewith. In the high-voltage generation circuit 3 of the modification of the third embodiment, even if the first voltage generation unit 54 is in the standby state, the potential at the node N34 can always be maintained at the voltage VS by a minute current passed through the resistor elements 135 and 136. Therefore, even if the first voltage generation unit 54 makes the transition from the standby state to the active state, the voltage VS can be output from the output terminal and stably maintained at the node N20. When the first voltage generation unit 54 is in the standby state, the ‘L’-level control signal SW20 is fed into the gate of the MOS transistor 134, thereby setting the MOS transistor 134 to the on state. When the generation unit 16 enters the active state, the ‘H’-level control signal SW20 is fed into the gate of the MOS transistor 134, thereby setting the MOS transistor 134 to the off state.

The high-voltage generation circuit 3 of the second and third embodiments can be applied to the read operation of the NOR-type flash memory of the first embodiment.

In the high-voltage generation circuit of each of the first to third embodiments, the read voltages VDDR to VDDR2 are produced for the four-value memory cell transistor MT. However, there is no limitation to the number of read voltages. That is, when the read operation is performed on an eight-value memory cell transistor MT, for example, seven voltages, VDDR to VDDR7, can be produced in the high-voltage generation circuit 3 of each of the first to third embodiments. A relationship of voltage VDDR1<voltage VDDR2< . . . <voltage VDDR6<voltage VDDR7 holds.

That is, the semiconductor storage device of each of the first to third embodiments includes the memory cell array, the word lines, the row decoder, and the voltage generation circuit. The memory cell array includes a plurality of memory cell transistors including the charge accumulation layer and the control gate, and the memory cell transistor can hold at least two-bit data. The word line is connected to the control gate of the memory cell transistor. The row decoder selects the word line. The voltage generation circuit transfers the second voltage to the row decoder. In order to read data from the memory cell transistor, the voltage generation circuit lowers the second voltage according to the data to be read.

Although the MONOS structure is described above, a memory cell having an FG-type configuration may be used. In the FG-type configuration, the stacked gate includes a floating gate (conductive layer) and a control gate. The floating gate is formed on the p-type semiconductor substrate with a gate insulator interposed therebetween. The control gate is formed on the floating gate with an inter-gate insulator interposed therebetween.

In the first to third embodiments, the NOR-type memory cell is provided by way of example. Alternatively a NAND-type flash memory may be provided. Both the MONOS-type and the FG-type may be adopted in the memory cell transistor MT constituting the NAND-type flash memory.

The control signals SW1 to SW10 and SW19 and inverted control signals /SW1 to /SW10 and /SW19 are simultaneously fed into the switch elements 31 to 33, the switch elements 44 to 49, and the switch element 131. Therefore, the switch elements 31 to 33, the switch elements 44 to 49, and the switch element 131 are set to the on state or the off state.

The voltage generation circuit of the third embodiments includes the p-channel type first MOS transistor, the n-channel type second MOS transistor, the p-channel type third MOS transistor, the n-channel type fourth MOS transistor, the voltage generation unit, and the switch circuit. In the n-channel type second MOS transistor, the drain end is connected to the source end of the first MOS transistor, the source end is connected to the first node, and the first gate voltage is applied to the gate. In the p-channel type third MOS transistor, the source end is connected to the first node, and the second gate voltage is applied to the gate. In the p-channel type fourth MOS transistor, the drain end is connected to the drain end of the third MOS transistor, and the source end is grounded. The voltage generation unit generates the first gate voltage and the second gate voltage according to the first voltage generated by the pump circuit. The switch circuit transfers the potential at the first node as the second voltage to the output end, or the switch circuit transfers the first voltage to the output end. When transferring the potential at the first node, the switch circuit is set to the on state such that the second voltage is output to the output end after the second voltage is applied to the first node. The second voltage is one of a difference in which the threshold of the n-channel type second MOS transistor is subtracted from the first gate voltage fed into the gate and a difference in which the threshold of the p-channel type third MOS transistor is subtracted from the second gate voltage fed into the gate.

### Fourth Embodiment

A voltage generation circuit according to a fourth embodiment of the invention and a semiconductor storage device provided therewith will be described below. In the fourth embodiment, the configuration and control of the high-voltage generation circuit 3 of each of the first to third embodiments and the modification of the third embodiment is partially changed and applied to a NAND-type flash memory. The high-voltage generation circuit 3 of the fourth embodiment generates a voltage VDDR3 (<voltage VDDR2) and a voltage VDDR4 (<voltage VDDR3) in addition to the voltage VDDR, the voltage VDDR1, and the voltage VDDR2. The voltages are transferred to the word line WL in the order of the voltage VDDR4, voltage VDDR3, voltage VDDR2, voltage VDDR1, and voltage VDDR, which are generated by the high-voltage generation circuit 3. In the fourth embodiment, the high-voltage generation circuit 3 generates five voltages. However, there is no particular limitation to the number of voltages. The high-voltage generation circuit 3 will be described as a first voltage generation circuit 410. In the high-voltage generation circuit 3 of the fourth embodiment, the descriptions of the same constituent and the operation thereof are omitted, and only a different configuration and an operation thereof are described.

(Entire Configuration of NAND-Type Flash Memory)

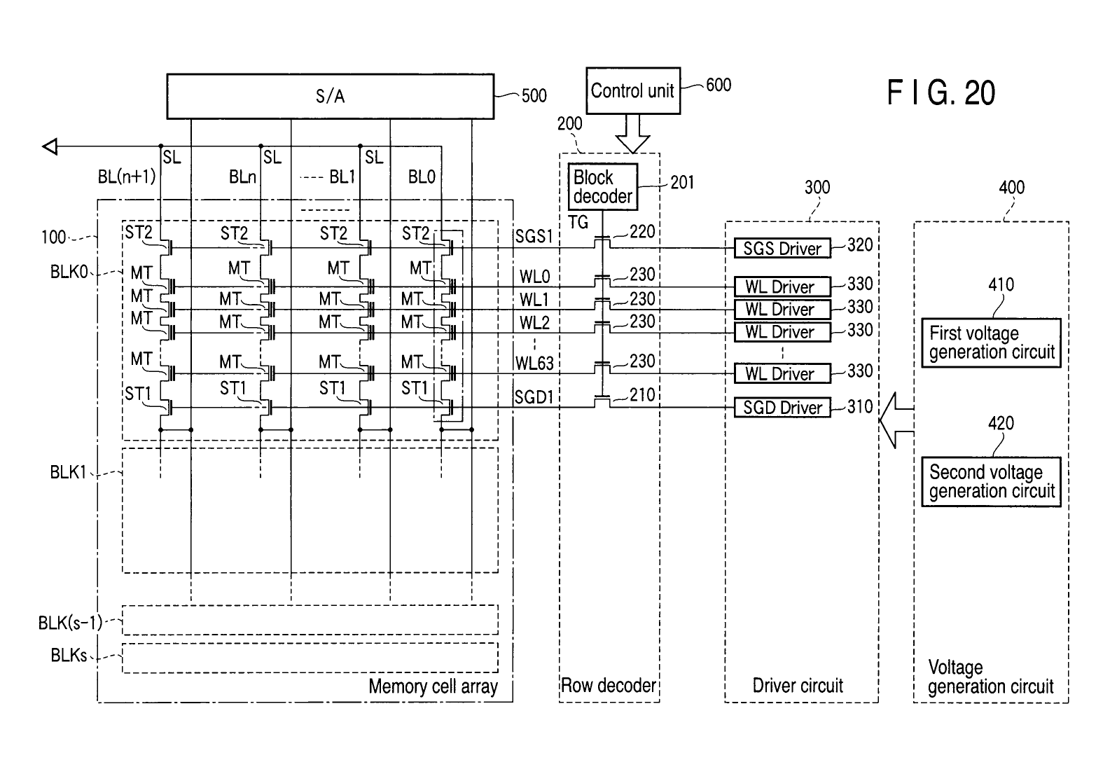

As illustrated in FIG. 20, the NAND-type flash memory includes a memory cell array 100, a row decoder 200, a driver circuit 300, a voltage generation circuit 400, a sense amplifier 500, and a control unit 600. First the memory cell array 100 will be described.

(Configuration Example of Memory Cell Array 100)

The memory cell array 100 includes a plurality of blocks BLK0 to BLKs (s is a natural number). Each of the blocks BLK0 to BLKs includes a plurality of NAND strings 110. Each of the NAND strings 110 includes selection transistors ST1 and ST2 in addition to a plurality of (for example, 64) memory cell transistors MT of FIG. 2. In each NAND string 110, the current pathways of the plurality of memory cell transistors MT are connected in series. The drain of the memory cell transistor MT on one end side (drain side) of the serial connection is connected to a source of the selection transistor ST1, and the source of the memory cell transistor MT on the other end side (source side) is connected to a drain of the selection transistor ST2.

In each of the blocks BLK0 to BLKs, the gates of the memory cell transistors MT located in the same row are commonly connected to one of the word lines WL0 to WL64, and the gates of the selection transistors ST1 and ST2 are commonly connected to the select gate lines SGD1 and SGS1, respectively. The number of memory cell transistors MT is not limited to 64, and 128, 256, or 512 memory cell transistors MT may be used. The number of memory cell transistors is not limited. For the sake of convenience, hereinafter sometimes the word lines WL0 to WL63 are simply referred to as word line WL unless distinguished from one another. In the memory cell array 100, the drains of the selection transistors ST1 located in the same column are commonly connected to one of the bit lines BL0 to BLn. Hereinafter sometimes the bit lines BL0 to BLn are simply referred to as bit line BL unless distinguished from one another (n is a natural number). The sources of the selection transistors ST2 are commonly connected to the source line SL.

The pieces of data are collectively written in the plurality of memory cell transistors MT connected to the same word line WL, and the unit is called a page. In the plurality of NAND strings 110, the pieces of data are collectively erased in units of blocks BLK. Because the threshold distribution of the memory cell transistor MT in the memory cell array 100 is similar to that of FIG. 3 of the first embodiment, the description is omitted.

(Row Decoder 200)

The row decoder 200 will be described below. The row decoder 200 includes a block decoder 201 and re-channel type MOS transistors 210, 220, and 230. During the data write operation, data read operation, and data erase operation, the block decoder 201 decodes a block address supplied from the control unit 600 and selects the block BLK based on the decoding result. That is, the block decoder 201 selects a control line TG connected to the MOS transistors 210, 220, and 230 corresponding to the block BLK including the selected memory cell transistor MT and sets the MOS transistors 210, 220, and 230 to the on state. At this point, the block decoder 201 outputs a block selection signal. The block selection signal means a signal with which the row decoder 200 selects one of the plurality of memory blocks BLK0 to BLKs during the data write operation, data read operation, and data erase operation. The row decoder 200 selects the row direction of the memory cell array 100 using the block selection signal. The row direction of the memory cell array 100 corresponds to the selected block BLK. That is, based on the block selection signal supplied from the block decoder 201, the row decoder 200 applies the voltage supplied from the driver circuit 300 to the select gate lines SGD1 and SGS1 and the word lines WL0 to WL63.

(Driver Circuit 300)

The driver circuit 300 will be described below.

The driver circuit 300 includes select gate line drivers 310 and 320 that are provided in each of select gate lines SGD1 and SGS1 and a word line driver 330 that is provided in each word line WL. In the fourth embodiment, only the word line driver 330 and select gate line drivers 310 and 320 corresponding to the block BLK0 are illustrated. However, actually the word line driver 330 and select gate line drivers 310 and 320 are commonly connected to the 64 word lines WL and select gate lines SGD1 and SGS1, which are provided in the blocks BLK0 to BLKs.

When the selected block BLK is selected according to the decoding result of the page address supplied from the control unit 600, the word line driver 330 transfers the necessary voltage supplied from the voltage generation circuit 400 to the control gate of the memory cell transistor MT through the selected word line WL.

When the selected block BLK is selected according to the decoding result of the row address (page address) supplied from the control unit 600, the select gate line driver 310 transfers the necessary voltage to the gate of the selection transistor ST1 through the select gate line SGD1 corresponding to the block BLK. At this point, a signal sgd is transferred to the gate. That is, during the data write operation, data read operation, data erase operation, and data verification in the memory cell transistor MT, the select gate line driver 310 transfers the signal sgd to the gate of the selection transistor ST1 through the select gate line SGD1. In the signal sgd, it is assumed that the ‘L’ level is 0 V while the ‘H’ level is the voltage VDD.

As with the select gate line driver 310, when the selected block BLK is selected, the select gate line driver 320 transfers the necessary voltage to the gate of the selection transistor ST2 through the select gate line SGS1 during the data write operation, data read operation, and data verification in the memory cell transistor MT. It is assumed that the ‘L’ level of a signal sgs is 0 V while the ‘H’ level is the voltage VDD.

(Voltage Generating Circuit 400)

The voltage generation circuit 400 will be described below. As illustrated in FIG. 20, the voltage generation circuit 400 includes a first voltage generation circuit 410 and a second voltage generation circuit 420. The first voltage generation circuit 410 generates the voltage VDDR, voltage VDDR1, voltage VDDR2, voltage VDDR3 (<voltage VDDR2), and voltage VDDR4 (<voltage VDDR3) in reading the data and transfers the voltages to the memory cell array 100 through the driver circuit 300 and the row decoder 200. The voltage VDDR, the voltage VDDR1, the voltage VDDR2, the voltage VDDR3, and the voltage VDDR4 are voltages corresponding to the pieces of data to be read from the memory cell transistor MT.

The second voltage generation circuit 420 generates a voltage VPGM in writing the data and transfers the voltage VPGM to the selection word line WL. The voltage VPGM is a voltage having an extent in which the charge in the channel of the memory cell transistor MT is injected into the charge accumulation layer to cause the threshold of the memory cell transistor MT to make a transition to another level.

Although not illustrated in FIG. 20, the voltage generation circuit 400 may include a circuit that generates voltages necessary for the data write, data read, and data erase in addition to the first and second voltage generation circuits 410 and 420.

(Sense Amplifier 500)

In reading the data, the sense amplifier 500 senses and amplifies the data read from the memory cell transistor MT to the bit line BL. Specifically, the sense amplifier 500 pre-charges the charge voltage to the bit line BL and senses the voltage (or current) in the bit line BL.

In writing the data, the sense amplifier 500 transfers one of ‘0’ V and the charge voltage transferred from the voltage generation circuit 4 to the bit line BL.

(Control Unit 600)

The control unit 600 will be described below. The control unit 600 controls the operation of the whole NAND-type flash memory. Based on the address and command supplied from a host (not illustrated), the control unit 600 performs operating sequences in the data write operation, read operation, and erase operation. The control unit 600 produces the block selection signal and the column selection signal based on the address and operating sequence. The control unit 600 outputs the block selection signal to the row decoder 200.

(Data Write Method)

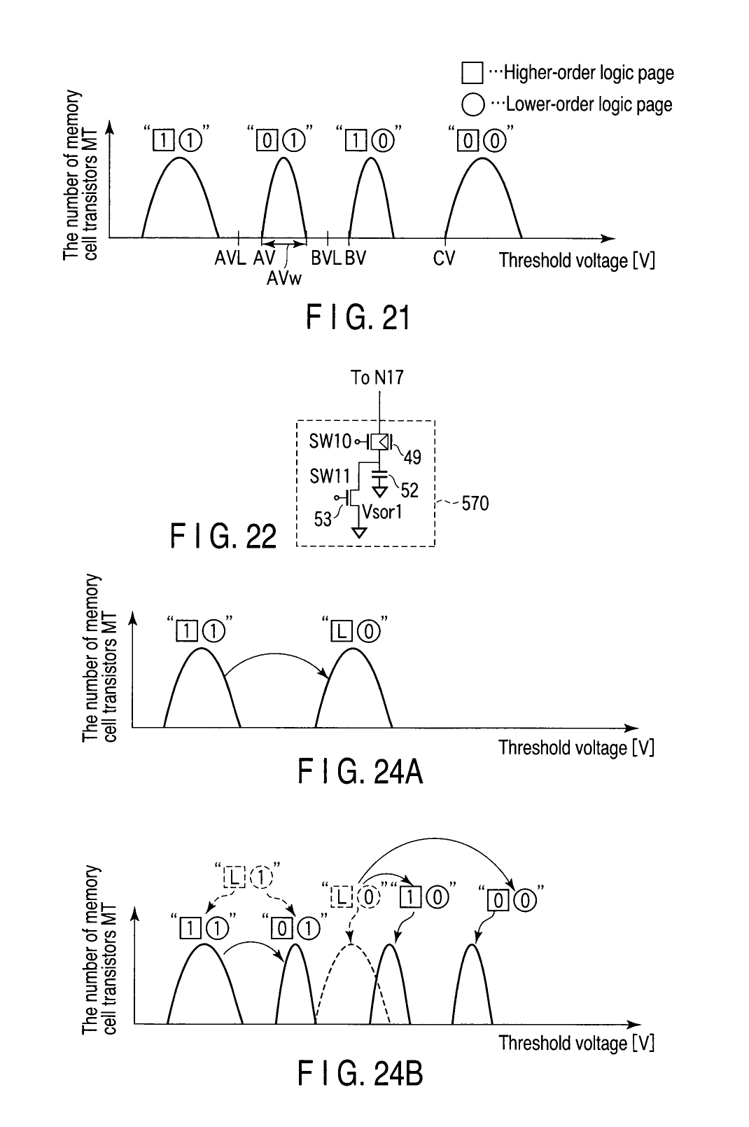

The data write method in the NAND-type flash memory of the fourth embodiment will be described with reference to FIG. 21. FIG. 21 is a graph illustrating the threshold distribution of the memory cell transistor MT.

As illustrated in FIG. 21, the memory cell transistor MT holds one of pieces of data. The pieces of data include ‘erase level’, ‘A’, ‘B’, and ‘C’ in ascending order of threshold voltage. The memory cell transistor MT of the fourth embodiment, for example, holds one of the four-level thresholds, that is, the two-bit data.

The erase level is set to ‘11’, the ‘A’ data is set to ‘01’, the ‘B’ data is set to ‘10’, and the ‘C’ data is set to ‘00’. One bit of the two-bit data is indicated as logic lower-order bit data by a mark “O”. The other bit is indicated as logic higher-order bit data by a mark “␣”. The ‘11’ data indicates the erase state, and the memory cell transistor MT in the erase state has a negative threshold voltage Vth. The bit may be allocated to the ‘erase level’, ‘A’, ‘B’, and ‘C’ in another way.

Roughly, the data write is performed by a repetition of a program operation and a verify operation. In the program operation, the voltage VPGM is applied to the word line to inject the charge into the charge accumulation layer, thereby raising the threshold. In the verify operation, after the program operation, the data is read to confirm whether the threshold reaches the desired value.

A well known data write method called Quick Pass Write is adopted in the fourth embodiment. Until the threshold reaches a certain level, the program operation is performed while the voltage of 0 V is applied to the bit line BL. After the threshold reaches a certain level, the program operation is performed while the positive voltage VDD1 (for example, 0.5 V) is applied to the bit line BL.

Until the threshold reaches a certain level, the amount of charge injected into the charge accumulation layer is increased to increase the fluctuation in threshold. Then, after the threshold reaches a certain level, the amount of charge injected into the charge accumulation layer is decreased to finely set the threshold.

Referring to FIG. 21, for example, when the ‘01’ data is written, the program operation in which the voltage of 0 V is applied to the bit line BL and the verify operation in which the read level is set to a verification level AVL are repeated until the threshold reaches the verification level AVL. The program operation, in which the voltage VDD1 is applied to the bit line BL, and the verify operation, in which the read level is set to AV (>AVL), are repeated after the threshold reaches the verification level AVL.

Therefore, a distribution AVw of FIG. 21 is obtained. The same holds true for the case in which the ‘10’ data is written. After the verify operation in which the read level is set to BVL is performed, the verify operation in which the read level is set to BV (>BVL) is performed.

The ‘00’ data can be written by the repetition of the program operation in which the voltage of 0 V is applied to the bit line BL and the verify operation in which the read level is set to CV.

(Generation Unit 16 of First Voltage Generating Circuit 410)

The generation unit 16 of the first voltage generation circuit 410 will be described with reference to FIG. 4. In the configuration of FIG. 4 of the first embodiment, because the generation unit 16 of the fourth embodiment further produces two kinds of voltages in addition to the voltages VDDR1 and VDDR, the generation unit 16 is changed as follows.

1) A resistor element 58 is provided to produce the voltage VDDR3.

2) A resistor element 59 is provided to produce the voltage VDDR4.

3) While one end of the resistor element 39 is not grounded, the other end of the resistor element 39 is set to a node N37.

4) One end of the resistor element 58 is connected to the node N37, the other end of the resistor element 58 is connected to one end of the resistor element 59 through a node N38, and the other end of the resistor element 59 is grounded.

5) Therefore, the voltage VDDR3 is transferred from the node N37 to the node N2.

6) The voltage VDDR4 is transferred from the node N38.

7) A switch element 68 is connected between the nodes N37 and N2.

8) A switch element 69 is connected between the nodes N38 and N2.

9) The switch element 68 is controlled to be set to the on state by a control signal SW21, thereby electrically connecting the nodes N37 and N2.

10) The switch element 31 is controlled to be set to the on state by a control signal SW22, thereby electrically connecting the nodes N38 and N2.

11) The discharge unit 57 is eliminated and replaced with a charge unit 570. The charge unit 570 will be described below.

(Charge Unit 570)

The charge unit 570 will be described with reference to FIG. 22. FIG. 22 is a block diagram of the charge unit 570.

The charge unit 570 has a configuration in which an external voltage Vₛₒᵤ is fed into the other end of the current pathway of the MOS transistor 53 in the discharge unit 57 of FIG. 4. Other configurations of the charge unit 570 are identical to those of the discharge unit 57. The charge unit 570 is provided in each of the nodes from which the voltages VDDR to VDDR4 are output, that is, in each of the nodes N8, N17, N16, N37, and N38. The charge unit 570 has a function of supplementing the potentials at the nodes. That is, the switch element 49 is set to the on state to transfer the charge of the charged capacitor 52 to each node.

The charge transferred to each node from the capacitor 52 is obtained as the charge unit 570 connected to the node N17 as an example. In the high-voltage generation circuit 3 of the fourth embodiment, as described above, the voltages are transferred to the word line WL in the order of the voltage VDDR4, voltage VDDR3, voltage VDDR2, voltage VDDR1, and voltage VDDR. That is, the switching operations of the switch element 31 to 33 are reversely performed by the control signal SW1 to SW3 of FIG. 6. Specifically, after the switch element 69 is switched from the on state to the off state, the switch element 68 is switched from the on state to the off state. Then the switch element 33 is switched from the on state to the off state. Then the switch element 32 is switched from the on state to the off state. Then the switch element 31 is switched from the on state to the off state.

For example, in FIG. 4, when the switch element 32 is switched from the on state after the switch element 33 is switched from the on state to the off state, the potential at the node N2 is changed from the voltage VDDR2 to the voltage VDDR1. At this point, a potential difference of the voltage (VDDR2−VDDR1) is generated between the nodes N2 and N5, and the potential difference is applied to the parasitic capacitor 30. Therefore, a charge Q′ₒᵤₜ corresponding to Cₒᵤₜ×(VDDR2−VDDR1) is transferred from the node N5 to the node N19, that is, from the node N17 to the node N19. Because the potential at the node N17 drops from the voltage VDDR1, the charge unit 570 compensates the potential at the node N17. At this point, a charge Q′_{cs} accumulated in the capacitor element 52 is expressed by the following equation (11):

Q′_{cs}=C′_{cs}×(VDDR1−Vₛₒᵤ) (11)

In such cases, the charge Q′ₒᵤₜ transferred from the node N17 to the node N2 may be supplemented by the charge Q′_{cs}. Therefore, the relationship between the charges Q′ₒᵤₜ and Q′_{cs} can be expressed by the following equation (12). The equation (11) is obtained on the assumption C1>>>Cout, as described in the first embodiment.

Q′ₒᵤₜ=Q′_{cs} (12)

From the equation (12), the capacitance C′_{cs} of the capacitor element 52 can be expressed by the following equation (13):

C′_{cs}=(VDDR2−VDDR1)/(VDDR1−Vₛₒᵤ)×Cₒᵤₜ (13)

As described above, because the high-voltage generation circuit 3 transfers the voltages to the word line WL in ascending order of voltage, it is necessary to satisfy the relationship of VDDR2>Vₛₒᵤ. Thus, only the charge unit 570 connected to the node N17 is particularly described. However, as described above, in addition to the node N16 of FIG. 4, it is necessary to provide similar charge units 570 between the node N37 and the switch element 68 and between the nodes N8 and N13. The capacitance C′_{cs} of the capacitor element 52 in the charge unit 570 at the node N16 is expressed by the following equation (14):

C′_{cs}=(VDDR3−VDDR2)/(VDDR2−Vₛₒᵤ)×Cₒᵤₜ (14)

The capacitance C′_{cs} of the capacitor element 52 in the charge unit 570 connected between the node N37 and the switch element 68 is expressed by the following equation (15):

C′_{cs}=(VDDR4−VDDR3)/(VDDR3−Vₛₒᵤ)×Cₒᵤₜ (15)

The capacitance C′_{cs} of the capacitor element 52 in the charge unit 570 connected between the nodes N8 and N13 is expressed by the following equation (16):

C′_{cs}=(VDDR1−VDDR)/(VDDR−Vₛₒᵤ)×Cₒᵤₜ (16)

The charge unit 570 may be provided between the node N38 and the switch element 69. However, in the generation unit 16 of the fourth embodiment, it is not necessary to operate the charge unit 570 provided between the node N38 and the switch element 69. In the following description, it is assumed that the voltage VDDR4 is a voltage AVL, the voltage VDDR3 is a voltage AV, the voltage VDDR2 is a voltage BVL, the voltage VDDR1 is a voltage BV, and the voltage VDDR is a voltage CV.

(Operation of Generation Unit 16 in Program Verify Operation)

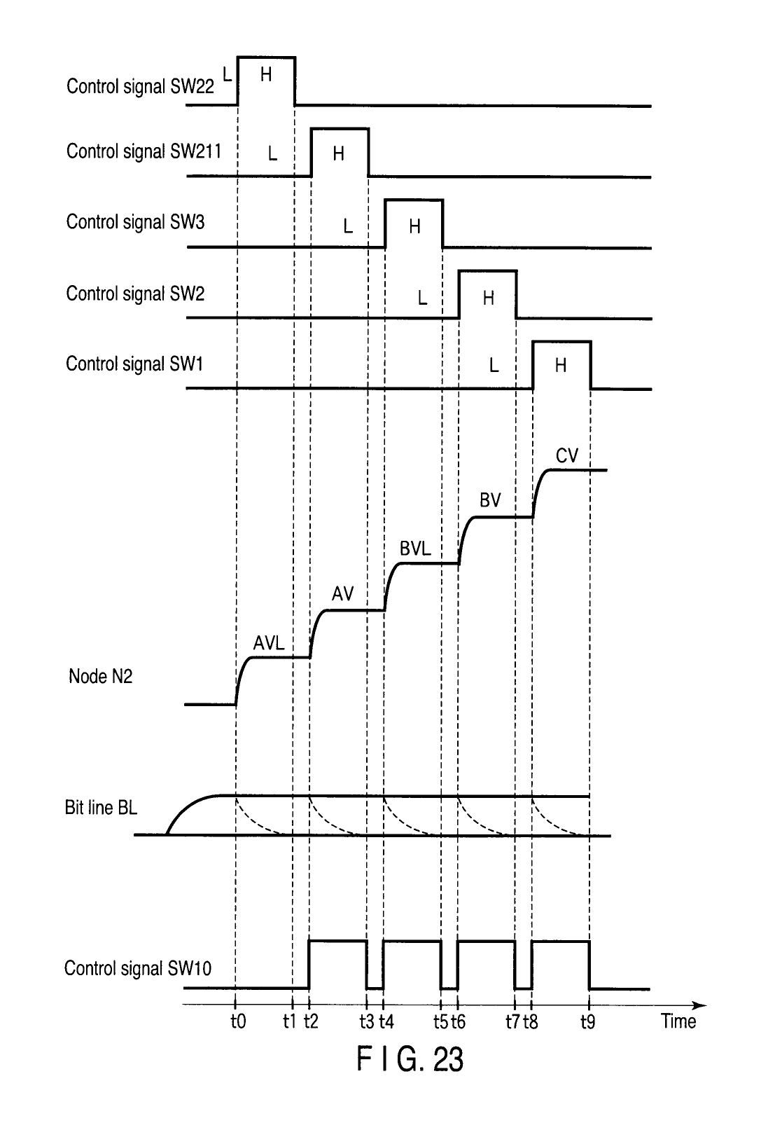

The voltage transfer operation of the generation unit 16 in a program verify operation for confirming whether the data is written in the program operation will be described with reference to FIG. 23. The voltage transfer operation performed by the generation unit 16 of the fourth embodiment is performed in the program verify operation. The program verify operation and STEP2 in which the Quick Pass Write is adopted are alternately performed in writing the data. That is, after the program operation of STEP2, the voltage AVL, voltage AV, voltage BVL, voltage BV, and voltage CV are sequentially transferred to the memory cell transistor MT in order to confirm the threshold distribution of the plurality of memory cell transistors MT. The threshold distribution is formed at the intersection of the selection word line WL with the selection bit line BL. At this point, it is assumed that the selection word line WL is the word line WL32. That is, a voltage VPASS is transferred to the non-selection word lines WL0 to WL31 and the non-selection word lines WL33 to 63. The voltage VPASS means a voltage at which the memory cell transistor MT is switched to the on state, and the voltage generation circuit 4 produces the voltage VPASS. In FIG. 23, the vertical axis indicates control signals and the potential at the node N2, and the horizontal axis indicates the time.

FIG. 23 is a timing chart illustrating the times the control signals SW21 and SW22 fed into the switch elements 68 and 69 and the control signals SW1 to SW3 fed into the switch elements 31 to 33 are switched, the voltage at the node N2, the voltage at the bit line BL, and the time the control signal SW10 is switched. The vertical axis indicates the level of the control signal fed into each switch element, that is, the ‘L’ level and the ‘H’ level, and the horizontal axis indicates the time. It is assumed that the switch elements 31 to 33, the switch elements 68 and 69, and the switch element 49 are set to the off state at the ‘L’ level while the switch elements 31 to 33, the switch elements 68 and 69, and the switch element 49 are set to the on state at the ‘H’ level. Because operation timing of the control signal SW11 fed into the gate of the MOS transistor 53 is the same FIG. 6, the description is omitted.

Before the time t0, in order to switch the switch elements 31 to 33, the switch elements 68 and 69, and switch element 49 to the off state, the control unit 600 sets the control signals SW1 to SW3, control signals SW21 and SW22, and control signal SW10 to the ‘L’ level. At the time t0, in order to transfer the voltage AVL to the word line WL32 through the node N2, the control unit 600 sets the control signal SW22 fed into the switch element 69 from the ‘L’ level to the ‘H’ level. Therefore, when one of the plurality of memory cell transistors MT connected to the word line WL32 is in the erase state, that is, when one of the plurality of memory cell transistors MT holds the ‘11’ data, the memory cell transistor MT that holds the ‘11’ data is set to the on state. The NAND string 110 including the memory cell transistor MT is put in the conduction state, the potential at the bit line BL makes the transition from the charge voltage to 0 V. When the memory cell transistors MT connected to the word line WL are not in the erase state, because the conduction state is not established in the NAND string 110, the bit line BL maintains the charge voltage. At the time t1, the control unit 600 sets the control signal SW22 fed into the switch element 69 to the ‘L’ level. Therefore, the potential at the node N2 enters the floating state to maintain the voltage AVL.

At the time t2, in order that the generation unit 16 transfers the voltage AV to the word line WL32 through the node N2, the control unit 600 switches the control signal SW21 fed into the switch element 68 from the ‘L’ level to the ‘H’ level. Further, at the time t2, the control unit 600 switches the control signal SW10 fed into the switch element 49 from the ‘L’ level to the ‘H’ level. Therefore, a predetermined charge is transferred from the capacitor element 52 to the node N37. As a result, the potential at the node N37, maintained in the voltage AV, is transferred to the node N2. In the plurality of memory cell transistors MT connected to the word line WL32, the memory cell transistor MT having a threshold distribution that includes the erase state and is lower than the voltage AV is set to the on state. Therefore, the NAND string 110 including the memory cell transistor MT set to the on state is put in the conduction state, and the potential at the bit line BL makes the transition from the charge voltage to 0 V. When the memory cell transistors MT connected to the word line WL do not have the threshold distribution that includes the erase state and is lower than the voltage AV, that is, when all the memory cell transistors MT have threshold distributions higher than the voltage AV, because the conduction state is not established in the NAND string 110, the bit line BL maintains the charge voltage. At the time t3, the control unit 600 switches the control signal SW21 fed into the switch element 68 to the ‘L’ level. Therefore, the potential at the node N2 enters the floating state to maintain the voltage AV.

Further, at the time t3, the control unit 600 switches the control signal SW10 fed into the switch element 49 to the ‘L’ level.

At the time t4, in order that the generation unit 16 transfers the voltage BVL to the word line WL32 through the node N2, the control unit 600 switches the control signal SW3 fed into the switch element 33 from the ‘L’ level to the ‘H’ level. Further, at the time t4, the control unit 600 switches the control signal SW10 fed into the switch element 49 from the ‘L’ level to the ‘H’ level. Therefore, the potential at the node N10, maintained at the voltage BVL, is transferred to the node N2. In the plurality of memory cell transistors MT connected to the word line WL32, the memory cell transistor MT that holds the ‘11’ data or ‘01’ data and that has a threshold distribution lower than the voltage BVL is set to the on state. Therefore, the NAND string 110 including the memory cell transistor MT set to the on state is put in the conduction state, and the potential at the bit line BL makes the transition from the charge voltage to 0 V. When the memory cell transistors MT connected to the word line WL do not have a threshold distribution lower than the voltage BVL, that is, when all the memory cell transistors MT have threshold distributions higher than the voltage BVL, because the conduction state is not established in the NAND string 110, the bit line BL maintains the charge voltage. At the time t5, the control unit 600 switches the control signal SW3 fed into the switch element 33 to the ‘L’ level. Therefore, the potential at the node N2 enters the floating state to maintain the voltage BVL. Further, at the time t5, the control unit 600 switches the control signal SW10 fed into the switch element 49 to the ‘L’ level.

At the time t6, in order that the generation unit 16 transfers the voltage BV to the word line WL32 through the node N2, the control unit 600 switches the control signal SW2 fed into the switch element 32 from the ‘L’ level to the ‘H’ level. Further, at the time t6, the control unit 600 switches the control signal SW10 fed into the switch element 49 from the ‘L’ level to the ‘H’ level. Therefore, the potential at the node N9, maintained at the voltage BV, is transferred to the node N2. In the plurality of memory cell transistors MT connected to the word line WL32, the memory cell transistor MT that holds the ‘11’ data or ‘01’ data and has a threshold distribution lower than the voltage BV is set to the on state. Therefore, the NAND string 110 including the memory cell transistor MT set to the on state is put in the conduction state, and the potential at the bit line BL makes the transition from the charge voltage to 0 V. When the memory cell transistors MT connected to the word line WL do not have a threshold distribution lower than the voltage BV, that is, when all the memory cell transistors MT have threshold distributions higher than the voltage BV, because the conduction state is not established in the NAND string 110, the bit line BL maintains the charge voltage. At the time t7, the control unit 600 switches the control signal SW2 fed into the switch element 32 to the ‘L’ level. Therefore, the potential at the node N2 enters the floating state to maintain the voltage BV. Further, at the time t7, the control unit 600 switches the control signal SW10 fed into the switch element 49 to the ‘L’ level.

At the time t8, in order that the generation unit 16 transfers the voltage CV to the word line WL32 through the node N2, the control unit 600 switches the control signal SW1 fed into the switch element 31 from the ‘L’ level to the ‘H’ level. Further, at the time t8, the control unit 600 switches the control signal SW10 fed into the switch element 49 from the ‘L’ level to the ‘H’ level. Therefore, the potential at the node N8, maintained in the voltage CV, is transferred to the node N2. In the plurality of memory cell transistors MT connected to the word line WL32, the memory cell transistor MT that holds the ‘11’ data, ‘01’ data, or ‘10’ data and has a threshold distribution lower than the voltage CV is set to the on state. Therefore, the NAND string 110 including the memory cell transistor MT set to the on state is put in the conduction state, and the potential at the bit line BL makes the transition from the charge voltage to 0 V at the time t8. When the memory cell transistors MT connected to the word line WL do not have a threshold distribution lower than the voltage BVL, that is, when all the memory cell transistors MT have threshold distributions higher than the voltage BVL, because the conduction state is not established in the NAND string 110, the bit line BL maintains the charge voltage. At the time t9, the control unit 600 switches the control signal SW1 fed into the switch element 31 to the ‘L’ level. Therefore, the potential at the node N2 enters the floating state to maintain the voltage CV. Further, at the time t9, the control unit 600 switches the control signal SW10 fed into the switch element 49 to the ‘L’ level.

(Effect of Fourth Embodiment)

The following effect (7) can be obtained in the high-voltage generation circuit of the fourth embodiment and the semiconductor storage device provided therewith.

(7) The Operating Reliability can be Improved (Part 5).

In the high-voltage generation circuit of the fourth embodiment and the semiconductor storage device provided therewith, the charge unit 570 is connected to the node at which the voltages such as the voltage VDDR and the voltage VDDR1 are produced and has the function of supplementing the charge according to the change in potential at the node. For example, when the control signal SW1 is switched to the on state after the control signal SW2 is switched from the on state to the off state, the charge is supplemented to the lowered potential at the node N8 by the charge unit 570, so that the voltage VDDR can stably be generated at the node N8 and the voltage VDDR can quickly be transferred to the word line WL. A similar effect can be obtained at not only the node N8 but also each node connected to the charge unit 570. Thus, in the fourth embodiment, the voltage can stably be transferred to the word line WL in switching the voltage.

The potentials at the nodes N8, N17, N16, N68, and N69 rapidly reach predetermined values by the charges supplemented from the charge unit 570. That is, the necessary voltage can quickly be transferred to the word line WL and stabilized. Therefore, a waiting time until the potential at the word line WL is stabilized in the program verify operation can be shortened, that is, the problem that the switching cannot be performed on the next switch element until the potential at the word line WL is stabilized can be avoided. In other words, because the switching can quickly be performed between the switch elements 31 to 33 and the switch elements 68 and 69, even if the number of voltages used in the program verify operation is increased as the number of levels is increased, such as 8 values or 16 values or more, not only 4 values, but multiple voltages can quickly be switched to enhance the operating speed of the whole circuit.

The following data write method may be adopted in the NAND-type flash memory of the fourth embodiment.

FIGS. 24A and 24B are graphs illustrating a threshold change of the memory cell transistor MT according to a modification of the fourth embodiment. In FIGS. 24A and 24B, the mark “□” indicate that the data is unfixed. The scale of the abscissa in FIGS. 24A and 24B is same.

As illustrated in FIG. 24A, for example, a lower-order bit is written in the memory cell transistor MT connected to the word line WLi (i is a natural number that is one of 0 to 63). Then, before the higher-order bit is written for the word line WLi, the lower-order bit is written in the memory cell transistor MT connected to the word line WL(i+1) (see FIG. 24A).

Then, as illustrated in FIG. 24B, the higher-order bit is written for the word line WLi. Therefore, the threshold of the memory cell transistor MT connected to the word line WLi is fixed to one of the four levels.

Before the higher-order bit is written for a certain word line WLi, the lower-order bit is written for the word line WL(i+1) adjacent to the word line WLi, and the higher-order bit is written for the word line WLi while the lower-order bit is already written for the word line WL(i+1). According to such method, in performing the program operation for a certain word line WLi, the influence on the threshold distribution of the word line WL(i+1) adjacent to the word line WLi can be suppressed to the minimum.

In the data write of FIG. 24B, the data write method (Quick pass write) of FIG. 21 can be applied, and the method of FIG. 23 can also be applied.

Thus, when the program operation is separately performed on the data of the higher-order bit and the data of the lower-order bit, the voltage transfer of FIG. 23 can be applied in the verify operation. Alternatively, as illustrated in FIG. 21, for example, the verify operation may be performed after the program operation is performed from the erase state to one of the state distributions of the ‘01’ data, ‘10’ data, and ‘00’ data.

The high-voltage generation circuit 3 of the first embodiment is applied to the voltage generation circuit used for the program verify operation in the data write method. Alternatively, the high-voltage generation circuits 3 of the second and third embodiments and the modification of the third embodiment may be applied. That is, for example, in FIG. 8, in addition to the first generation unit 54 that produces the voltage VDDR1 and the second generation unit 55 that produces the voltage VDDR2, the third and fourth generation units that produce the voltages VDDR3 and VDDR4 and the switch circuit that switches the voltages VDDR3 and VDDR4 produced by the third and fourth generation units may be provided between the nodes N60 and N62. At this point, the time the on and off of the switch circuit are switched is set in the order of the switch circuit that outputs the voltage VDDR4 produced by the fourth generation unit to the node N62, the switch circuit that outputs the voltage VDDR3 produced by the third generation unit to the node N62, the switch circuit 23, the switch circuit 22, and the switch circuit 21. Therefore, even in the high-voltage generation circuits 3 of the second and third embodiments and the modification of the third embodiment, the voltage VDDR4, the voltage VDDR3, the voltage VDDR2, the voltage VDDR1, and the voltage VDDR are output in order from the node N2. That is, assuming that the voltage VDDR4 is the voltage AVL, the voltage VDDR3 is the voltage AV, the voltage VDDR2 is the voltage BVL, the voltage VDDR1 is the voltage BV, and the voltage VDDR is the voltage CV, the high-voltage generation circuits 3 of the second and third embodiments and the modification of the third embodiment can be applied to the program verify operation in the data write method.

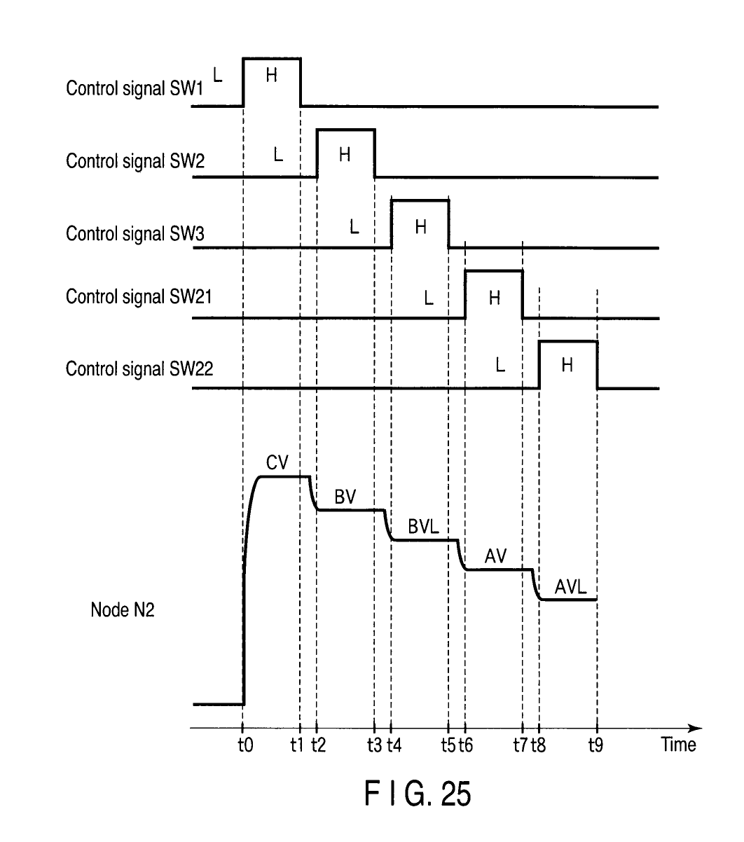

In the high-voltage generation circuit 3 of the fourth embodiment, during the program verify operation, the voltages are stepped up from the voltage VDDR4 to the voltage VDDR to confirm the threshold distribution of the memory cell transistor MT. Alternatively, the voltage transfer may be reversed. That is, the voltages may be stepped down from the voltage VDDR to the voltage VDDR4. In such cases, in the high-voltage generation circuit 3 of the fourth embodiment, the charge units 570 connected to the nodes at which the voltages VDDR to VDDR4 are output may be eliminated to provide the discharge units 57 at the nodes. At this point, the time the control signals SW1 to SW3 for controlling the on and off of each switch element and the control signals SW10 and SW11 for controlling the switch element 49 and 53 are switched is similar to that of FIG. 6. The same holds true for the control signals SW21 and SW22. The state of the voltage transfer operation in which the voltages VDDR to VDDR4 produced by the high-voltage generation circuit 3 are sequentially stepped down and transferred to the word line WL will be described with reference to FIG. 25.

FIG. 25 is a timing chart illustrating control signals for controlling the switch elements and a timing chart illustrating the voltage at the node N2. As illustrated in FIG. 25, the vertical axis indicates the voltages of the control signals for controlling the switch elements and the node N2, and the horizontal axis indicates the time.

As illustrated in FIG. 25, at the time t0, time t2, time t4, time t6, and time t8, the control signals SW1 to SW3 and the control signals SW21 and SW22 are set to the ‘H’ level. Therefore, the potential at the node N2 is lowered in the order of the voltage CV, voltage BV, voltage BVL, voltage AV, and voltage AVL. The high-voltage generation circuit 3 in which the voltages are sequentially transferred from the node N2 may be used as a program verify voltage for the program operation in which the Quick Pass Write is adopted. Similarly, in the high-voltage generation circuits 3 of the second and third embodiments and the modification of the third embodiments, the voltages may be output from the node N2 in the order of the voltage VDDR, voltage VDDR1, voltage VDDR2, voltage, VDDR3, and voltage VDDR4.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voltage generation circuit comprising:
a pump circuit which generates a first voltage and outputs the first voltage to a first node;
a first voltage generation unit which includes a first resistance unit to output a second voltage at a second node, one end of the first resistance unit being connected to the first node, the first resistance unit dividing the first voltage to generate the second voltage;
a first switch element which connects the second node and an output terminal, a resistance value of a parasitic resistance formed in an interconnection from the second node to the output terminal being smaller than a resistance value of the first resistance unit; and
a first capacitor element in which one of electrodes is connected to an interconnection connecting the second node and the first switch element while the other of the electrodes is grounded, a capacitance of the first capacitor element being larger than a capacitance connected to the output terminal.

2. The circuit according to claim 1, further comprising:
a second voltage generation unit which includes a second resistance unit to output a third voltage at a third node, one end of the second resistance unit being connected to the first node while the other end of the second resistance unit is grounded through a second switch element, the second resistance unit dividing the first voltage;
a third switch element which connects the second node and the third node; and
a discharge unit which discharges a charge at the second node, wherein
the second resistance unit generates the third voltage having a value identical to a value of the second voltage by setting the second switch element to an on state, and the third switch element connects the second node and third node having an equal potential.

3. The circuit according to claim 2, wherein the discharge unit includes:
a first MOS transistor in which one end of a current path is connected to the second node, and which has a gate receiving a first control signal;
a second capacitor element in which one of electrodes is connected to the other end of the first MOS transistor while the other of the electrodes is grounded; and
a second MOS transistor in which one end of a current path is connected to the other end of the first MOS transistor, a second control signal being fed into a gate of the second MOS transistor, the other end of the current path of the second MOS transistor is grounded,
wherein a capacitance of the second capacitor element is expressed as follows:
C_{cs2}=(VDDR−VDDR1)/(VDDR1−Vₛₛ)×Cₒᵤₜ
where C_{cs2} is the capacitance of the second capacitor element, VDDR is the first voltage, VDDR1 is the second voltage, Vₛₛ is a potential at the other end of the second capacitor element, and Cₒᵤₜ is the capacitance of the output terminal.

4. The circuit according to claim 3, further comprising:
a delay circuit which delays a third control signal, the third control signal used to control and fed into the first switch element being fed into the first switch element; and
an operation unit which performs an operation on the third control signal and the third control signal delayed by the delay circuit and supplies an operation result as the second control signal to the gate of the second MOS transistor.

5. The circuit according to claim 3, wherein, after the second MOS transistor is set to the off state using the second control signal at the same time as the first switch element is set to the on state, the first MOS transistor is set to the on state using the first control signal, and the first switch element is set to the off state while the second MOS transistor is set to the on state.

6. The circuit according to claim 1, wherein the capacitance of the first capacitor element is one hundred or more times the capacitance connected to the output terminal.

7. The circuit according to claim 1, further comprising a fourth switch element which connects the first node and the output terminal,
wherein the first switch element is set to the on state after the fourth switch element is set to the off state in reading data.

8. The circuit according to claim 1, further comprising:
a second voltage generation unit which includes a second resistance unit to output a third voltage at a third node, one end of the second resistance unit being connected to the first node while the other end of the second resistance is grounded through a second switch element, the second resistance unit dividing the first voltage;
a third switch element which connects the second node and the third node; and
a charge unit which charges the second node,
wherein the second resistance unit generates the third voltage having a value identical to a value of the second voltage by setting the second switch element to an on state, and the third switch element connects the second node and third node having an equal potential.

9. The circuit according to claim 8, wherein the charge unit includes:
a first MOS transistor in which one end is connected to the second node, and has a gate receiving a first control signal;
a second capacitor element in which one of electrodes is connected to the other end of the first MOS transistor while an external voltage is supplied to the other of the electrodes; and
a second MOS transistor in which one end of a current path is connected to the other end of the first MOS transistor, a second control signal being fed into a gate of the second MOS transistor, the other end of the current path of the second MOS transistor is grounded,
wherein a capacitance of the second capacitor element is expressed as follows:
C_{cs2}=(VDDR1−VDDR)/(VDDR1−Vₛₒᵤ)×Cₒᵤₜ
where C_{cs2} is the capacitance of the second capacitor element, VDDR is the first voltage, VDDR1 is the second voltage, Vₛₒᵤ is the external voltage supplied to the other end of the current path of the first MOS transistor and is larger than VDDR1, and Cₒᵤₜ is the capacitance of the output terminal.

10. The circuit according to claim 9, wherein the second node is maintained at the second voltage by simultaneously setting the third control signal and the first control signal to the on state.

11. A semiconductor storage device comprising:
a memory cell array which includes a plurality of memory cell transistors including a charge accumulation layer and a control gate capable of holding data two or more bit;
a word line which is connected to the control gate of each of the memory cell transistors;
the voltage generation circuit according to claim 9; and
a row decoder which selects the word line in verifying the memory cell transistor and applies the first voltage and the second voltage to the selected word line, the voltage generation circuit outputting the first voltage after outputting the second voltage to the row decoder.

12. A semiconductor storage device comprising:
a memory cell array which includes a plurality of memory cell transistors including a charge accumulation layer and a control gate to be able to hold two-bit data or more;
a word line which is connected to the control gate of the memory cell transistor;
the voltage generation circuit according to claim 1; and
a row decoder which selects the word line in reading data and applies the first voltage or the second voltage to the selected word line according to the data to be read, the voltage generation circuit outputting the second voltage after outputting the first voltage to the row decoder.

13. A voltage generation circuit comprising:
a p-channel type first MOS transistor in which one end of a current path is connected to an external power supply while the other end of the current path is connected to a first node, a voltage at the first node being externally output;
an n-channel type second MOS transistor in which one end of a current path and a gate are connected to the first node while the other end of the current path is connected to a second node;
a first resistor element in which one end is connected to the second node while the other end is connected to a third node which becomes a potential sensing target;
a second resistor element in which one end is connected to the third node while the other end is grounded; and
a comparator which compares a reference potential corresponding to a potential sensing level at the third node and a voltage at the third node, and controls the first MOS transistor according to the comparison result.

14. The circuit according to claim 13, wherein the voltage at the first node is determined by a voltage-current characteristic of the second MOS transistor and a load line of the first resistor element and second resistor element.

15. The circuit according to claim 13, further comprising:
a p-channel type third MOS transistor in which one end of a current path is connected to the second node while the other end of the current path and a gate are connected to a fourth node; and
a third resistor element in which one end is connected to the fourth node while the other end is grounded,
wherein the voltage at the first node is externally output as a first voltage, and the voltage at the fourth node is externally output as a second voltage.

16. A semiconductor circuit device comprising:
the voltage generation circuit according to claim 15;
a p-channel type fourth MOS transistor;
an n-channel type fifth MOS transistor in which a drain end is connected to a source end of the fourth MOS transistor, and which has a source end connected to a fifth node, the first voltage is applied as a first gate voltage to a gate of the fifth MOS transistor;
a p-channel type sixth MOS transistor in which a source end is connected to the fifth node while the second voltage is applied as a second gate voltage to a gate;
an n-channel type seventh MOS transistor in which a drain end is connected to a drain end of the sixth MOS transistor while a source end is grounded; and
a first switch circuit which transfers a potential at the fifth node as a fourth voltage to an output end or transfers a third voltage to the output end, the third voltage generated by a pump circuit is applied as a external power supplying to the voltage generation circuit, and the voltage generation circuit generation the first voltage and the second voltage according to the third voltage, and
the first switch circuit outputting a potential at the third voltage or the fifth node, and first switch circuit entering an on state so as to output the fourth voltage to the output end after the fourth voltage is applied to the fifth node in transferring the voltage at the fifth node, the fourth voltage being one of a difference in which a threshold of the n-channel type fifth MOS transistor is subtracted from the first voltage and a difference in which a threshold of the p-channel type sixth MOS transistor is subtracted from the second voltage fed into the gate of the p-channel type sixth MOS transistor.

17. A semiconductor storage device comprising:
a memory cell array which includes a plurality of memory cell transistors including a charge accumulation layer and a control gate to be able to hold two-bit data or more;
a word line which is connected to the control gate of the memory cell transistor;
the semiconductor integrated circuit device according to claim 16; and
a row decoder which selects the word line in reading data and applies the third voltage or the fourth voltage to the selected word line according to the data to be read, the voltage generation circuit outputting the fourth voltage after outputting the third voltage to the row decoder

18. A semiconductor storage device comprising:
a memory cell array which includes a plurality of memory cell transistors including a charge accumulation layer and a control gate to be able to hold two-bit data or more;
a word line which is connected to the control gate of the memory cell transistor;
the semiconductor circuit device according to claim 16; and
a row decoder which selects the word line in verifying the memory cell transistor and applies the third voltage and the fourth voltage to the selected word line, the semiconductor integrated circuit device outputting the third voltage after outputting the fourth voltage to the row decoder.

19. A voltage generation circuit comprising:
a p-channel type first MOS transistor in which one end of a current path is connected to an external power supply while the other end of the current path is connected to a first node;
a first resistor element in which one end is connected to the first node while the other end is connected to a second node becoming a potential sensing target;
a second resistor element in which one end is connected to the second node while the other end is grounded;
a comparator which compares a reference potential corresponding to a potential sensing level at the second node and a voltage at the second node and controls the first MOS transistor according to the comparison result;
a p-channel type second MOS transistor in which one end of a current path is connected to the first node while the other end of the current path and a gate are connected to a third node, a voltage at the third node being externally output; and
a third resistor element in which one end is connected to the third node while the other end is grounded.

20. The circuit according to claim 19, wherein the voltage at the first node is determined by a voltage-current characteristic of the second MOS transistor and a load line of the first resistor element and second resistor element.
